(19) United States
(12) Patent Application Publication
(10) Pub. No.: US 2024/0244440 A1
(43) Pub. Date: Jul. 18, 2024

(54) SYSTEMS AND METHODS TO SUPPORT PRIVATE NETWORKS IN 5G DISTRIBUTED ANTENNA SYSTEMS

(71) Applicant: CommScope Technologies LLC, Claremont, NC (US)

(72) Inventor: Harsha Hegde, Buffalo Grove, IL (US)

(73) Assignee: CommScope Technologies LLC, Claremont, NC (US)

(21) Appl. No.: 18/412,084

(22) Filed: Jan. 12, 2024

Related U.S. Application Data
(60) Provisional application No. 63/479,626, filed on Jan. 12, 2023.
(60) Provisional application No. 63/479,660, filed on Jan. 12, 2023.

(51) Int. Cl. H04W 16/10; H04B 7/024

(52) U.S. Cl. CPC H04W 16/10; H04B 7/024; H04W 84/045

(57) ABSTRACT

Systems and methods for supporting private networks using a DAS are provided. In one example, a method for supporting a private network with a DAS includes determining whether a private network is activated and connected to the DAS. The method further includes determining one or more paths of the DAS impacted by the private network. The method further includes receiving an indication of available resources and capability information for one or more components in the DAS. The method further includes dedicating resources of the DAS to the private network based on requirements of the private network and the available resources for the one or more components of the DAS. The method further includes utilizing the resources of the DAS dedicated to the private network for traffic having an identifier corresponding to the private network.

### CROSS-REFERENCE TO RELATED APPLICATIONS

This application claims priority to U.S. Provisional Application No. 63/479,660, filed on Jan. 12, 2023, and titled “SYSTEMS AND METHODS TO SUPPORT PRIVATE NETWORKS IN 5G DISTRIBUTED ANTENNA SYSTEMS,” and to U.S. Provisional Application No. 63/479,626, filed on Jan. 12, 2023, and titled “SYSTEMS AND METHODS TO SUPPORT NETWORK SLICING IN 5G DISTRIBUTED ANTENNA SYSTEMS,” the contents of all of which are incorporated by reference herein in their entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units”), where each access point can be coupled directly to one or more of the central access nodes or indirectly via one or more other remote units and/or via one or more intermediary or expansion units or nodes (also referred to here as “transport expansion nodes (TENs)”). A DAS is typically used to improve the coverage provided by one or more base stations that are coupled to the central access nodes. These base stations can be coupled to the one or more central access nodes via one or more cables or via a wireless connection, for example, using one or more donor antennas. The wireless service provided by the base stations can include commercial cellular service and/or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals that are radiated from one or more coverage antennas associated with that access point. The downlink radio frequency signals are radiated for reception by user equipment (UEs). Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits them to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, this involves, among other things, summing uplink signals received from all of the multiple access points in order to produce the base station signal provided to each base station. In this way, the DAS increases the coverage area for the uplink capacity provided by the base stations.

A DAS can use either digital transport, analog transport, or combinations of digital and analog transport for generating and communicating the transport signals between the central access nodes, the access points, and any transport expansion nodes.

### SUMMARY

In one aspect, a method for supporting a private network with a distributed antenna system is described herein. The method includes determining whether a private network is activated and connected to the distributed antenna system. The method further includes determining one or more paths of the distributed antenna system impacted by the private network. The method further includes receiving an indication of available resources and capability information for one or more components in the distributed antenna system. The method further includes dedicating resources of the distributed antenna system to the private network based on requirements of the private network and the available resources for the one or more components of the distributed antenna system. The method further includes utilizing the resources of the distributed antenna system dedicated to the private network for traffic having an identifier corresponding to the private network.

In another aspect, a system for supporting a private network with a distributed antenna system is described herein. The system includes a master unit of a distributed antenna system. The master unit is configured to be coupled to one or more base station entities of a private network. The system further includes a plurality of radio units of the distributed antenna system communicatively coupled to the master unit, wherein the plurality of radio units is located remotely from the master unit. The system further includes at least one controller communicatively coupled to the master unit. The at least one controller is configured to determine whether the private network is activated and connected to the distributed antenna system. The at least one controller is further configured to determine one or more paths of the distributed antenna system impacted by the private network. The at least one controller is further configured to receive an indication of available resources and capability information for one or more components in the distributed antenna system. The at least one controller is further configured to dedicate resources of the distributed antenna system to the private network based on requirements of the private network and the available resources for the one or more components of the distributed antenna system. The system is configured to utilize the resources of the distributed antenna system dedicated to the private network for traffic having an identifier corresponding to the private network.

### BRIEF DESCRIPTION OF THE DRAWINGS

Comprehension of embodiments of the invention is facilitated by reading the following detailed description in conjunction with the annexed drawings, in which:

FIG. 1A is a block diagram illustrating an exemplary embodiment of a distributed antenna system (DAS) that is configured to serve one or more base stations;

FIG. 1B illustrates another exemplary embodiment of a DAS;

FIG. 1C illustrates another exemplary embodiment of a DAS;

FIG. 1D illustrates another exemplary embodiment of a DAS;

FIG. 2 illustrates another exemplary embodiment of a DAS;

FIG. 3 is a flow diagram of an example method for supporting network slicing in a DAS;

FIG. 4A illustrates another exemplary embodiment of a DAS;

FIG. 4B illustrates another exemplary embodiment of a DAS; and

FIG. 5 is a flow diagram of an example method for supporting private networks in a DAS.

### DETAILED DESCRIPTION

In the following detailed description, reference is made to the accompanying drawings that form a part hereof, and in which is shown by way of illustration specific illustrative embodiments. However, it is to be understood that other embodiments may be used, and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

In a fifth generation (5G) New Radio (NR) network, network slicing is an architectural concept to create logical and virtualized independent networks on the same physical network infrastructure in order to support different service level requirements (SLRs) around latency, throughput, etc. A network slice includes a share of transport resources (for example, dimensioning switches and routers to allocate certain transport paths to a set of traffic characteristics or use cases), core network resources (for example, number of compute instances required for a User Plane Function (UPF)), and radio access network resources (for example, number of compute instances required for a central unit user plane (CU-UP)). A network slice can be provisioned, for example, to support of a particular use case (for example, low latency applications) or a particular operator/enterprise so there is a guaranteed quality of service (QoS) or the requirements of a Service Level Agreement (SLA) can be met. Typically, a 3GPP 5G network dedicates resources of the base station entities (for example, central unit (CU) and distributed unit (DU)) to the network slice, and network slicing can be supported using Software-Defined Networking (SDN), Network Function Virtualization (NFV), orchestration, and other techniques. However, when a DAS is deployed to distribute the baseband signals, the independent logical networks do not generally account for the distribution of the baseband signals via the DAS, which could result in poor SLR performance.

Further, for 5G private network use cases where cellular towers may not provide sufficient coverage, the 5G private network may need to rely on a multi-operator, multi-band DAS for distribution of the baseband signals and a transport network. A multi-operator, multi-band DAS can be used to distribute baseband signals for public networks (for example, AT&T or Verizon), private networks on top of the public networks, and private networks run by a private enterprise using the same infrastructure. 5G private networks are expected to have their own end-to-end SLRs around latency and throughput that will need to be supported even when connected to a multi-operator, multi-band DAS for baseband signal distribution. However, when connected to a DAS, a 5G private network typically does not have sufficient control over the components of the DAS to guarantee that the specific SLRs for the 5G private network will be met.

While the problems described above involve 5G NR systems, similar problems exist in LTE. Therefore, although the following embodiments are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both standalone and non-standalone modes (or other modes developed in the future), and the following description is not intended to be limited to any particular mode. Also, unless explicitly indicated to the contrary, references to “layers” or a “layer” (for example, Layer-1, Layer-2, Layer-3, the Physical Layer, the MAC Layer, etc.) set forth herein refer to layers of the wireless interface (for example, 5G NR or 4G LTE) used for wireless communication between a base station and user equipment).

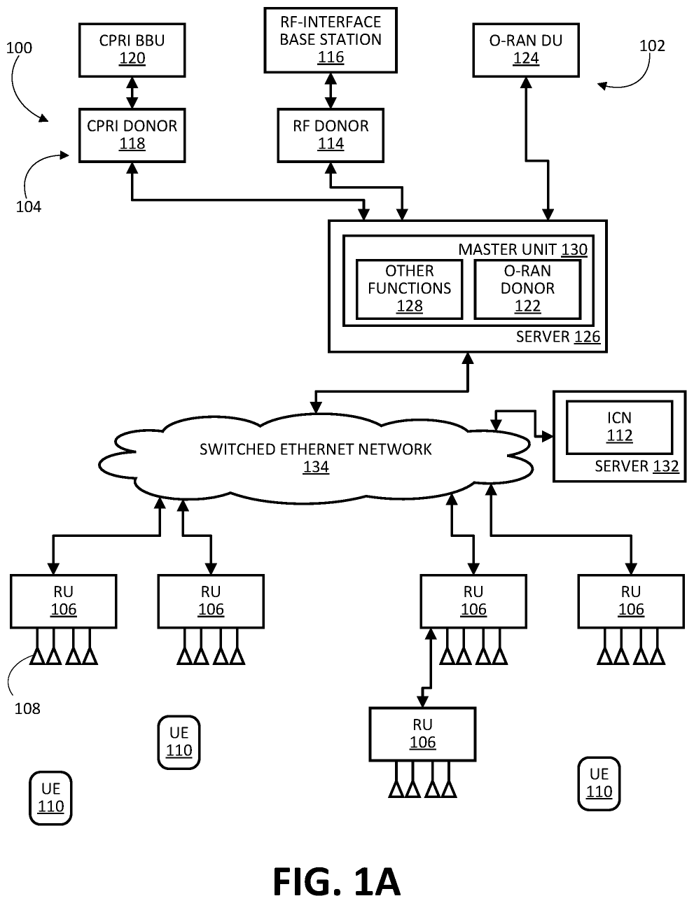

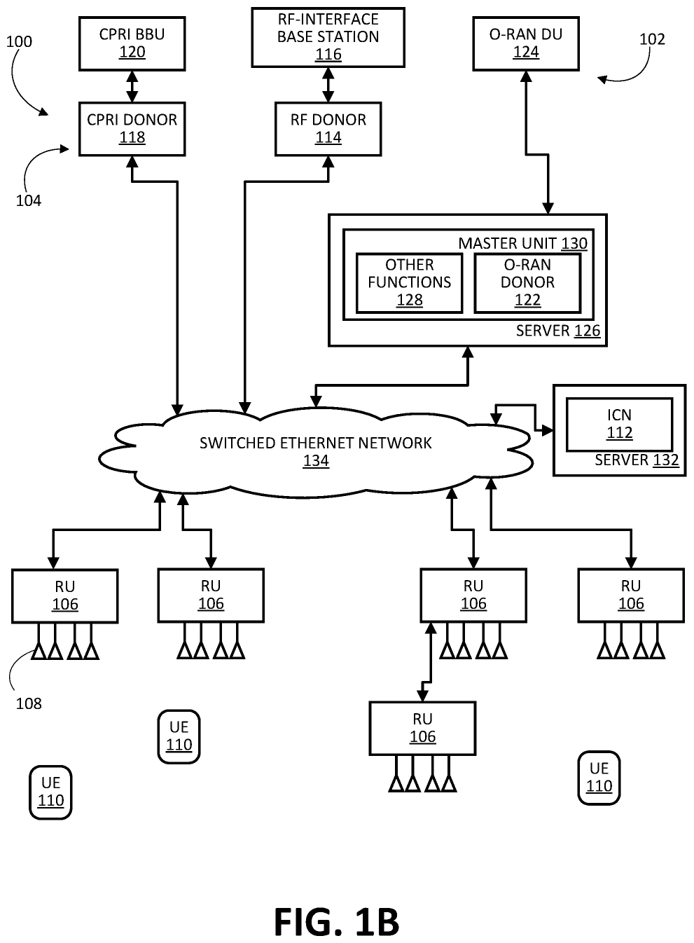

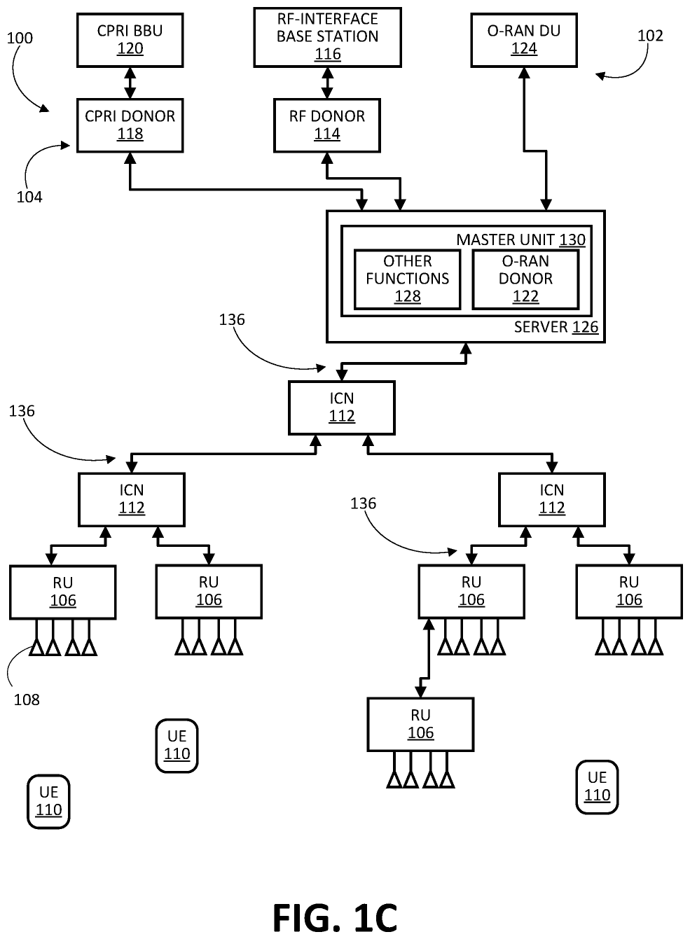

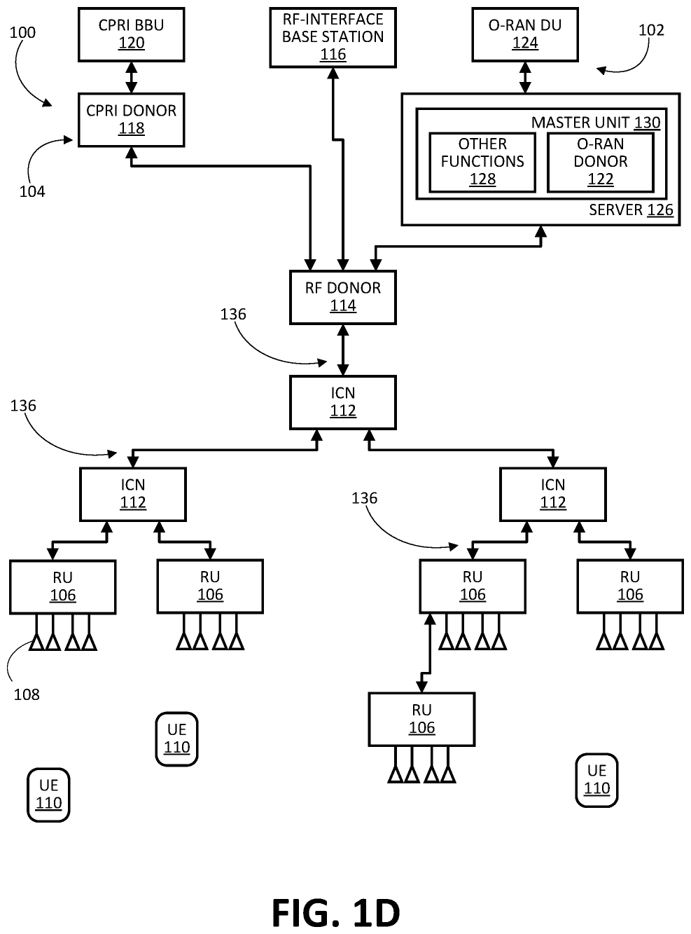

FIG. 1A is a block diagram illustrating an exemplary embodiment of a distributed antenna system (DAS) 100 that is configured to serve one or more base stations 102. In the exemplary embodiment shown in FIG. 1A, the DAS 100 includes one or more donor units 104 that are used to couple the DAS 100 to the base stations 102. The DAS 100 also includes a plurality of remotely located radio units (RUs) 106 (also referred to as “antenna units,” “access points,” “remote units,” or “remote antenna units”). The RUs 106 are communicatively coupled to the donor units 104.

Each RU 106 includes, or is otherwise associated with, a respective set of coverage antennas 108 via which downlink analog RF signals can be radiated to user equipment (UEs) 110 and via which uplink analog RF signals transmitted by UEs 110 can be received. The DAS 100 is configured to serve each base station 102 using a respective subset of RUs 106 (which may include less than all of the RUs 106 of the DAS 100). Also, the subsets of RUs 106 used to serve the base stations 102 may differ from base station 102 to base station 102. The subset of RUs 106 used to serve a given base station 102 is also referred to here as the “simulcast zone” for that base station 102. In general, the wireless coverage of a base station 102 served by the DAS 100 is improved by radiating a set of downlink RF signals for that base station 102 from the coverage antennas 108 associated with the multiple RUs 106 in that base station's simulcast zone and by producing a single “combined” set of uplink base station signals or data that is provided to that base station 102. The single combined set of uplink base station signals or data is produced by a combining or summing process that uses inputs derived from the uplink RF signals received via the coverage antennas 108 associated with the RUs 106 in that base station's simulcast zone.

The DAS 100 can also include one or more intermediary combining nodes (ICNs) 112 (also referred to as “expansion” units or nodes). For each base station 102 served by a given ICN 112, the ICN 112 is configured to receive a set of uplink transport data for that base station 102 from a group of “southbound” entities (that is, from RUs 106 and/or other ICNs 112) and generate a single set of combined uplink transport data for that base station 102, which the ICN 112 transmits “northbound” towards the donor unit 104 serving that base station 102. The single set of combined uplink transport data for each served base station 102 is produced by a combining or summing process that uses inputs derived from the uplink RF signals received via the coverage antennas 108 of any southbound RUs 106 included in that base station's simulcast zone. As used here, “southbound” refers to traveling in a direction “away,” or being relatively “farther,” from the donor units 104 and base stations 102, and “northbound” refers to traveling in a direction “towards,” or being relatively “closer” to, the donor units 104 and base stations 102.

In some configurations, each ICN 112 also forwards downlink transport data to the group of southbound RUs 106 and/or ICNs 112 served by that ICN 112. Generally, ICNs 112 can be used to increase the number of RUs 106 that can be served by the donor units 104 while reducing the processing and bandwidth load relative to having the additional RUs 106 communicate directly with each such donor unit 104.

Also, one or more RUs 106 can be configured in a “daisy-chain” or “ring” configuration in which transport data for at least some of those RUs 106 is communicated via at least one other RU 106. Each RU 106 would also perform the combining or summing process for any base station 102 that is served by that RU 106 and one or more of the southbound entities subtended from that RU 106. Such a RU 106 also forwards northbound all other uplink transport data received from its southbound entities.

The DAS 100 can include various types of donor units 104. One example of a donor unit 104 is an RF donor unit 114 that is configured to couple the DAS 100 to a base station 116 using the external analog radio frequency (RF) interface of the base station 116 that would otherwise be used to couple the base station 116 to one or more antennas (if the DAS 100 were not being used). This type of base station 116 is also referred to here as an “RF-interface” base station 116. An RF-interface base station 116 can be coupled to a corresponding RF donor unit 114 by coupling each antenna port of the base station 116 to a corresponding port of the RF donor unit 114.

Each RF donor unit 114 serves as an interface between each served RF-interface base station 116 and the rest of the DAS 100 and receives downlink base station signals from, and outputs uplink base station signals to, each served RF-interface base station 116. Each RF donor unit 114 performs at least some of the conversion processing necessary to convert the base station signals to and from the digital fronthaul interface format natively used in the DAS 100 for communicating time-domain baseband data. The downlink and uplink base station signals communicated between the RF-interface base station 116 and the donor unit 114 are analog RF signals. Also, in this example, the digital fronthaul interface format natively used in the DAS 100 for communicating time-domain baseband data can comprise the O-RAN fronthaul interface, a CPRI or enhanced CPRI (eCPRI) digital fronthaul interface format, or a proprietary digital fronthaul interface format (though other digital fronthaul interface formats can also be used).

Another example of a donor unit 104 is a digital donor unit that is configured to communicatively couple the DAS 100 to a baseband entity using a digital baseband fronthaul interface that would otherwise be used to couple the baseband entity to a radio unit (if the DAS 100 were not being used). In the example shown in FIG. 1A, two types of digital door units are shown.

The first type of digital donor unit comprises a digital donor unit 118 that is configured to communicatively couple the DAS 100 to a baseband unit (BBU) 120 using a time-domain baseband fronthaul interface implemented in accordance with a Common Public Radio Interface (“CPRI”) specification. This type of digital donor unit 118 is also referred to here as a “CPRI” donor unit 118, and this type of BBU 120 is also referred to here as a CPRI BBU 120. For each CPRI BBU 120 served by a CPRI donor unit 118, the CPRI donor unit 118 is coupled to the CPRI BBU 120 using the CPRI digital baseband fronthaul interface that would otherwise be used to couple the CPRI BBU 120 to a CPRI remote radio head (RRH) (if the DAS 100 were not being used). A CPRI BBU 120 can be coupled to a corresponding CPRI donor unit 118 via a direct CPRI connection.

Each CPRI donor unit 118 serves as an interface between each served CPRI BBU 120 and the rest of the DAS 100 and receives downlink base station signals from, and outputs uplink base station signals to, each CPRI BBU 120. Each CPRI donor unit 118 performs at least some of the conversion processing necessary to convert the CPRI base station data to and from the digital fronthaul interface format natively used in the DAS 100 for communicating time-domain baseband data. The downlink and uplink base station signals communicated between each CPRI BBU 120 and the CPRI donor unit 118 comprise downlink and uplink fronthaul data generated and formatted in accordance with the CPRI baseband fronthaul interface.

The second type of digital donor unit comprises a digital donor unit 122 that is configured to communicatively couple the DAS 100 to a BBU 124 using a frequency-domain baseband fronthaul interface implemented in accordance with a O-RAN Alliance specification. The acronym “O-RAN” is an abbreviation for “Open Radio Access Network.” This type of digital donor unit 122 is also referred to here as an “O-RAN” donor unit 122, and this type of BBU 124 is typically an O-RAN distributed unit (DU) and is also referred to here as an O-RAN DU 124. For each O-RAN DU 124 served by a O-RAN donor unit 122, the O-RAN donor unit 122 is coupled to the O-DU 124 using the O-RAN digital baseband fronthaul interface that would otherwise be used to couple the O-RAN DU 124 to a O-RAN RU (if the DAS 100 were not being used). An O-RAN DU 124 can be coupled to a corresponding O-RAN donor unit 122 via a switched Ethernet network. Alternatively, an O-RAN DU 124 can be coupled to a corresponding O-RAN donor unit 122 via a direct Ethernet or CPRI connection.

Each O-RAN donor unit 122 serves as an interface between each served O-RAN DU 124 and the rest of the DAS 100 and receives downlink base station signals from, and outputs uplink base station signals to, each O-RAN DU 124. Each O-RAN donor unit 122 performs at least some of any conversion processing necessary to convert the base station signals to and from the digital fronthaul interface format natively used in the DAS 100 for communicating frequency-domain baseband data. The downlink and uplink base station signals communicated between each O-RAN DU 124 and the O-RAN donor unit 122 comprise downlink and uplink fronthaul data generated and formatted in accordance with the O-RAN baseband fronthaul interface, where the user-plane data comprises frequency-domain baseband IQ data. Also, in this example, the digital fronthaul interface format natively used in the DAS 100 for communicating O-RAN fronthaul data is the same O-RAN fronthaul interface used for communicating base station signals between each O-RAN DU 124 and the O-RAN donor unit 122, and the “conversion” performed by each O-RAN donor unit 122 (and/or one or more other entities of the DAS 100) includes performing any needed “multicasting” of the downlink data received from each O-RAN DU 124 to the multiple RUs 106 in a simulcast zone for that O-RAN DU 124 (for example, by communicating the downlink fronthaul data to an appropriate multicast address and/or by copying the downlink fronthaul data for communication over different fronthaul links) and performing any need combining or summing of the uplink data received from the RUs 106 to produce combined uplink data provided to the O-RAN DU 124. It is to be understood that other digital fronthaul interface formats can also be used.

In general, the various base stations 102 are configured to communicate with a core network (not shown) of the associated wireless operator using an appropriate backhaul network (typically, a public wide area network such as the Internet). Also, the various base stations 102 may be from multiple, different wireless operators and/or the various base stations 102 may support multiple, different wireless protocols and/or RF bands.

In general, for each base station 102, the DAS 100 is configured to receive a set of one or more downlink base station signals from the base station 102 (via an appropriate donor unit 104), generate downlink transport data derived from the set of downlink base station signals, and transmit the downlink transport data to the RUs 106 in the base station's simulcast zone. For each base station 102 served by a given RU 106, the RU 106 is configured to receive the downlink transport data transmitted to it via the DAS 100 and use the received downlink transport data to generate one or more downlink analog radio frequency signals that are radiated from one or more coverage antennas 108 associated with that RU 106 for reception by user equipment 110. In this way, the DAS 100 increases the coverage area for the downlink capacity provided by the base stations 102. Also, for any southbound entities (for example, southbound RUs 106 or ICNs 112) coupled to the RU 106 (for example, in a daisy chain or ring architecture), the RU 106 forwards any downlink transport data intended for those southbound entities towards them.

For each base station 102 served by a given RU 106, the RU 106 is configured to receive one or more uplink radio frequency signals transmitted from the user equipment 110.

These signals are analog radio frequency signals and are received via the coverage antennas 108 associated with that RU 106. The RU 106 is configured to generate uplink transport data derived from the one or more remote uplink radio frequency signals received for the served base station 102 and transmit the uplink transport data northbound towards the donor unit 104 coupled to that base station 102.

For each base station 102 served by the DAS 100, a single “combined” set of uplink base station signals or data is produced by a combining or summing process that uses inputs derived from the uplink RF signals received via the RUs 106 in that base station's simulcast zone. The resulting final single combined set of uplink base station signals or data is provided to the base station 102. This combining or summing process can be performed in a centralized manner in which the combining or summing process is performed by a single unit of the DAS 100 (for example, a donor unit 104 or master unit 130). This combining or summing process can also be performed in a distributed or hierarchical manner in which the combining or summing process is performed by multiple units of the DAS 100 (for example, a donor unit 104 (or master unit 130) and one or more ICNs 112 and/or RUs 106). Each unit of the DAS 100 that performs the combining or summing process for a given base station 102 receives uplink transport data from that unit's southbound entities and uses that data to generate combined uplink transport data, which the unit transmits northbound towards the base station 102. The generation of the combined uplink transport data involves, among other things, extracting in-phase and quadrature (IQ) data from the received uplink transport data and performing a combining or summing process using any uplink IQ data for that base station 102 in order to produce combined uplink IQ data.

Some of the details regarding how base station signals or data are communicated and transport data is produced vary based on which type of base station 102 is being served. In the case of an RF-interface base station 116, the associated RF donor unit 114 receives analog downlink RF signals from the RF-interface base station 116 and, either alone or in combination with one or more other units of the DAS 100, converts the received analog downlink RF signals to the digital fronthaul interface format natively used in the DAS 100 for communicating time-domain baseband data (for example, by digitizing, digitally down-converting, and filtering the received analog downlink RF signals in order to produce digital baseband IQ data and formatting the resulting digital baseband IQ data into packets), and communicates the resulting packets of downlink transport data to the various RUs 106 in the simulcast zone of that base station 116. The RUs 106 in the simulcast zone for that base station 116 receive the downlink transport data and use it to generate and radiate downlink RF signals as described above. In the uplink, either alone or in combination with one or more other units of the DAS 100, the RF donor unit 114 generates a set of uplink base station signals from uplink transport data received by the RF donor unit 114 (and/or the other units of the DAS 100 involved in this process). The set of uplink base station signals is provided to the served base station 116. The uplink transport data is derived from the uplink RF signals received at the RUs 106 in the simulcast zone of the served base station 116 and communicated in packets.

In the case of a CPRI BBU 120, the associated CPRI digital donor unit 118 receives CPRI downlink fronthaul data from the CPRI BBU 120 and, either alone or in combination with another unit of the DAS 100, converts the received CPRI downlink fronthaul data to the digital fronthaul interface format natively used in the DAS 100 for communicating time-domain baseband data (for example, by re-sampling, synchronizing, combining, separating, gain adjusting, etc. the CPRI baseband IQ data, and formatting the resulting baseband IQ data into packets), and communicates the resulting packets of downlink transport data to the various RUs 106 in the simulcast zone of that CPRI BBU 120. The RUs 106 in the simulcast zone of that CPRI BBU 120 receive the packets of downlink transport data and use them to generate and radiate downlink RF signals as described above. In the uplink, either alone or in combination with one or more other units of the DAS 100, the CPRI donor unit 118 generates uplink base station data from uplink transport data received by the CPRI donor unit 118 (and/or the other units of the DAS 100 involved in this process). The resulting uplink base station data is provided to that CPRI BBU 120. The uplink transport data is derived from the uplink RF signals received at the RUs 106 in the simulcast zone of the CPRI BBU 120.

In the case of an O-RAN DU 124, the associated O-RAN donor unit 122 receives packets of O-RAN downlink fronthaul data (that is, O-RAN user-plane and control-plane messages) from each O-RAN DU 124 coupled to that O-RAN digital donor unit 122 and, either alone or in combination with another unit of the DAS 100, converts (if necessary) the received packets of O-RAN downlink fronthaul data to the digital fronthaul interface format natively used in the DAS 100 for communicating O-RAN baseband data, and communicates the resulting packets of downlink transport data to the various RUs 106 in a simulcast zone for that ORAN DU 124. The RUs 106 in the simulcast zone of each O-RAN DU 124 receive the packets of downlink transport data and use them to generate and radiate downlink RF signals as described above. In the uplink, either alone or in combination with one or more other units of the DAS 100, the O-RAN donor unit 122 generates packets of uplink base station data from uplink transport data received by the O-RAN donor unit 122 (and/or the other units of the DAS 100 involved in this process). The resulting packets of uplink base station data are provided to the O-RAN DU 124. The uplink transport data is derived from the uplink RF signals received at the RUs 106 in the simulcast zone of the served O-RAN DU 124 and communicated in packets.

In one implementation, one of the units of the DAS 100 is also used to implement a “master” timing entity for the DAS 100 (for example, such a master timing entity can be implemented as a part of a master unit 130 described below). In another example, a separate, dedicated timing master entity (not shown) is provided within the DAS 100. In either case, the master timing entity synchronizes itself to an external timing master entity (for example, a timing master associated with one or more of the O-DUs 124) and, in turn, that entity serves as a timing master entity for the other units of the DAS 100. A time synchronization protocol (for example, the Institute of Electrical and Electronics Engineers (IEEE) 1588 Precision Time Protocol (PTP), the Network Time Protocol (NTP), or the Synchronous Ethernet (SyncE) protocol) can be used to implement such time synchronization.

A management system (not shown) can be used to manage the various nodes of the DAS 100. In one implementation, the management system communicates with a predetermined “master” entity for the DAS 100 (for example, the master unit 130 described below), which in turns forwards or otherwise communicates with the other units of the DAS 100 for management-plane purposes. In another implementation, the management system communicates with the various units of the DAS 100 directly for management-plane purposes (that is, without using a master entity as a gateway).

Each base station 102 (including each RF-interface base station 116, CPRI BBU 120, and O-RAN DU 124), donor unit 104 (including each RF donor unit 114, CPRI donor unit 118, and O-RAN donor unit 122), RU 106, ICN 112, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.). Such entities can be implemented in other ways.

The DAS 100 can be implemented in a virtualized manner or a non-virtualized manner. When implemented in a virtualized manner, one or more nodes, units, or functions of the DAS 100 are implemented using one or more virtual network functions (VNFs) executing on one or more physical server computers (also referred to here as “physical servers” or just “servers”) (for example, one or more commercial-off-the-shelf (COTS) servers of the type that are deployed in data centers or “clouds” maintained by enterprises, communication service providers, or cloud services providers). More specifically, in the exemplary embodiment shown in FIG. 1A, each O-RAN donor unit 122 is implemented as a VNF running on a server 126. The server 126 can execute other VNFs 128 that implement other functions for the DAS 100 (for example, fronthaul, management plane, and synchronization plane functions). The various VNFs executing on the server 126 are also referred to here as “master unit” functions 130 or, collectively, as the “master unit” 130. Also, in the exemplary embodiment shown in FIG. 1A, each ICN 112 is implemented as a VNF running on a server 132.

The RF donor units 114 and CPRI donor units 118 can be implemented as cards (for example, Peripheral Component Interconnect (PCI) Cards) that are inserted in the server 126. Alternatively, the RF donor units 114 and CPRI donor units 118 can be implemented as separate devices that are coupled to the server 126 via dedicated Ethernet links or via a switched Ethernet network (for example, the switched Ethernet network 134 described below).

In the exemplary embodiment shown in FIG. 1A, the donor units 104, RUs 106, and ICNs 112 are communicatively coupled to one another via a switched Ethernet network 134. Also, in the exemplary embodiment shown in FIG. 1A, an O-RAN DU 124 can be coupled to a corresponding O-RAN donor unit 122 via the same switched Ethernet network 134 used for communication within the DAS 100 (though each O-RAN DU 124 can be coupled to a corresponding O-RAN donor unit 122 in other ways). In the exemplary embodiment shown in FIG. 1A, the downlink and uplink transport data communicated between the units of the

DAS 100 is formatted as O-RAN data that is communicated in Ethernet packets over the switched Ethernet network 134.

In the exemplary embodiment shown in FIG. 1A, the RF donor units 114 and CPRI donor units 118 are coupled to the RUs 106 and ICNs 112 via the master unit 130.

In the downlink, the RF donor units 114 and CPRI donor units 118 provide downlink time-domain baseband IQ data to the master unit 130. The master unit 130 generates downlink O-RAN user-plane messages containing downlink baseband IQ that is either the time-domain baseband IQ data provided from the donor units 114 and 118 or is derived therefrom (for example, where the master unit 130 converts the received time-domain baseband IQ data into frequency-domain baseband IQ data). The master unit 130 also generates corresponding downlink O-RAN control-plane messages for those O-RAN user-plane messages. The resulting downlink O-RAN user-plane and control-plane messages are communicated (multicasted) to the RUs 106 in the simulcast zone of the corresponding base station 102 via the switched Ethernet network 134.

In the uplink, for each RF-interface base station 116 and CPRI BBU 120, the master unit 130 receives O-RAN uplink user-plane messages for the base station 116 or CPRI BBU 120 and performs a combining or summing process using the uplink baseband IQ data contained in those messages in order to produce combined uplink baseband IQ data, which is provided to the appropriate RF donor unit 114 or CPRI donor unit 118. The RF donor unit 114 or CPRI donor unit 118 uses the combined uplink baseband IQ data to generate a set of base station signals or CPRI data that is communicated to the corresponding RF-interface base station 116 or CPRI BBU 120. If time-domain baseband IQ data has been converted into frequency-domain baseband IQ data for transport over the DAS 100, the donor unit 114 or 118 also converts the combined uplink frequency-domain IQ data into combined uplink time-domain IQ data as part of generating the set of base station signals or CPRI data that is communicated to the corresponding RF-interface base station 116 or CPRI BBU 120.

In the exemplary embodiment shown in FIG. 1A, the master unit 130 (more specifically, the O-RAN donor unit 122) receives downlink O-RAN user-plane and control-plane messages from each served O-RAN DU 124 and communicates (multicasts) them to the RUs 106 in the simulcast zone of the corresponding O-RAN DU 124 via the switched Ethernet network 134. In the uplink, the master unit 130 (more specifically, the O-RAN donor unit 122) receives O-RAN uplink user-plane messages for each served O-RAN DU 124 and performs a combining or summing process using the uplink baseband IQ data contained in those messages in order to produce combined uplink IQ data. The O-RAN donor unit 122 produces O-RAN uplink user-plane messages containing the combined uplink baseband IQ data and communicates those messages to the O-RAN DU 124.

In the exemplary embodiment shown in FIG. 1A, only uplink transport data is communicated using the ICNs 112, and downlink transport data is communicated from the master unit 130 to the RUs 106 without being forwarded by, or otherwise communicated using, the ICNs 112.

FIG. 1B illustrates another exemplary embodiment of a DAS 100. The DAS 100 shown in FIG. 1B is the same as the DAS 100 shown in FIG. 1A except as described below. In the exemplary embodiment shown in FIG. 1B, the RF donor units 114 and CPRI donor units 118 are coupled directly to the switched Ethernet network 134 and not via the master unit 130, as is the case in the embodiment shown in FIG. 1A.

As described above, in the exemplary embodiment shown in FIG. 1A, the master unit 130 performs some transport functions related to serving the RF-interface base stations 116 and CPRI BBUs 120 coupled to the donor units 114 and 118. In the exemplary embodiment shown in FIG. 1B, the RF donor units 114 and CPRI donor units 118 perform those transport functions (that is, the RF donor units 114 and CPRI donor units 118 perform all of the transport functions related to serving the RF-interface base stations 116 and CPRI BBUs 120, respectively).

FIG. 1C illustrates another exemplary embodiment of a DAS 100. The DAS 100 shown in FIG. 1C is the same as the DAS 100 shown in FIG. 1A except as described below. In the exemplary embodiment shown in FIG. 1C, the donor units 104, RUs 106 and ICNs 112 are communicatively coupled to one another via point-to-point Ethernet links 136 (instead of a switched Ethernet network). Also, in the exemplary embodiment shown in FIG. 1C, an O-RAN DU 124 can be coupled to a corresponding O-RAN donor unit 122 via a switched Ethernet network (not shown in FIG. 1C), though that switched Ethernet network is not used for communication within the DAS 100. In the exemplary embodiment shown in FIG. 1C, the downlink and uplink transport data communicated between the units of the DAS 100 is communicated in Ethernet packets over the point-to-point Ethernet links 136.

For each southbound point-to-point Ethernet link 136 that couples a master unit 130 to an ICN 112, the master unit 130 assembles downlink transport frames and communicates them in downlink Ethernet packets to the ICN 112 over the point-to-point Ethernet link 136. For each point-to-point Ethernet link 136, each downlink transport frame multiplexes together downlink time-domain baseband IQ data and Ethernet data that needs to be communicated to southbound RUs 106 and ICNs 112 that are coupled to the master unit 130 via that point-to-point Ethernet link 136. The downlink time-domain baseband IQ data is sourced from one or more RF donor units 114 and/or CPRI donor units 118. The Ethernet data comprises downlink user-plane and control-plane O-RAN fronthaul data sourced from one or more O-RAN donor units 122 and/or management-plane data sourced from one or more management entities for the DAS 100. That is, this Ethernet data is encapsulated into downlink transport frames that are also used to communicate downlink time-domain baseband IQ data and this Ethernet data is also referred to here as “encapsulated” Ethernet data. The resulting downlink transport frames are communicated in the payload of downlink Ethernet packets communicated from the master unit 130 to the ICN 112 over the point-to-point Ethernet link 136. The Ethernet packets into which the encapsulated Ethernet data is encapsulated are also referred to here as “transport” Ethernet packets.

Each ICN 112 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. Any encapsulated Ethernet data that is intended for the ICN 112 (for example, management-plane Ethernet data) is processed by the ICN 112.

For each southbound point-to-point Ethernet link 136 coupled to the ICN 112, the ICN 112 assembles downlink transport frames and communicates them in downlink Ethernet packets to the southbound entities subtended from the ICN 112 via the point-to-point Ethernet link 136. For each southbound point-to-point Ethernet link 136, each downlink transport frame multiplexes together downlink time-domain baseband IQ data and Ethernet data received at the ICN 112 that needs to be communicated to those subtended southbound entities. The resulting downlink transport frames are communicated in the payload of downlink transport Ethernet packets communicated from the ICN 112 to those subtended southbound entities ICN 112 over the point-to-point Ethernet link 136.

Each RU 106 receives downlink transport Ethernet packets via each northbound point-to-point Ethernet link 136 and extracts any downlink time-domain baseband IQ data and/or encapsulated Ethernet data included in the downlink transport frames communicated via the received downlink transport Ethernet packets. As described above, the RU 106 uses any downlink time-domain baseband IQ data and/or downlink O-RAN user-plane and control-plane fronthaul messages to generate downlink RF signals for radiation from the set of coverage antennas 108 associated with that RU 106. The RU 106 processes any management-plane messages communicated to that RU 106 via encapsulated Ethernet data.

Also, for any southbound point-to-point Ethernet link 136 coupled to the RU 106, the RU 106 assembles downlink transport frames and communicates them in downlink Ethernet packets to the southbound entities subtended from the RU 106 via the point-to-point Ethernet link 136. For each southbound point-to-point Ethernet link 136, each downlink transport frame multiplexes together downlink time-domain baseband IQ data and Ethernet data received at the RU 106 that needs to be communicated to those subtended southbound entities. The resulting downlink transport frames are communicated in the payload of downlink transport Ethernet packets communicated from the RU 106 to those subtended southbound entities ICN 112 over the point-to-point Ethernet link 136.

In the uplink, each RU 106 generates uplink time-domain baseband IQ data and/or uplink O-RAN user-plane fronthaul messages for each RF-interface base station 116, CPRI BBU 120, and/or O-RAN DU 124 served by that RU 106 as described above. For each northbound point-to-point Ethernet link 136 of the RU 106, the RU 106 assembles uplink transport frames and communicates them in uplink transport Ethernet packets northbound towards the appropriate master unit 130 via that point-to-point Ethernet link 136. For each northbound point-to-point Ethernet link 136, each uplink transport frame multiplexes together uplink time-domain baseband IQ data originating from that RU 106 and/or any southbound entity subtended from that RU 106 as well as any Ethernet data originating from that RU 106 and/or any southbound entity subtended from that RU 106. In connection with doing this, the RU 106 performs the combining or summing process described above for any base station 102 served by that RU 106 and also by one or more of the subtended entities. (The RU 106 forwards northbound all other uplink data received from those southbound entities.) The resulting uplink transport frames are communicated in the payload of uplink transport Ethernet packets northbound towards the master unit 130 via the associated point-to-point Ethernet link 136.

Each ICN 112 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. For each northbound point-to-point Ethernet link 136 coupled to the ICN 112, the ICN 112 assembles uplink transport frames and communicates them in uplink transport Ethernet packets northbound towards the master unit 130 via that point-to-point Ethernet link 136. For each northbound point-to-point Ethernet link 136, each uplink transport frame multiplexes together uplink time-domain baseband IQ data and Ethernet data received at the ICN 112 that needs to be communicated northbound towards the master unit 130. In connection with doing this, the ICN 112 performs the combining or summing process described above for any base station 102 served by that ICN 112 for which it has received uplink baseband IQ data from multiple entities subtended from that ICN 112. The resulting uplink transport frames are communicated in the payload of uplink transport Ethernet packets communicated northbound towards the master unit 130 over the point-to-point Ethernet link 136.

Each master unit 130 receives uplink transport Ethernet packets via each southbound point-to-point Ethernet link 136 and extracts any uplink time-domain baseband IQ data and/or encapsulated Ethernet data included in the uplink transport frames communicated via the received uplink transport Ethernet packets. Any extracted uplink time-domain baseband IQ data, as well as any uplink O-RAN messages communicated in encapsulated Ethernet, is used in producing a single “combined” set of uplink base station signals or data for the associated base station 102 as described above (which includes performing the combining or summing process). Any other encapsulated Ethernet data (for example, management-plane Ethernet data) is forwarded on towards the respective destination (for example, a management entity).

In the exemplary embodiment shown in FIG. 1C, synchronization-plane messages are communicated using native Ethernet packets (that is, non-encapsulated Ethernet packets) that are interleaved between the transport Ethernet packets.

FIG. 1D illustrates another exemplary embodiment of a DAS 100. The DAS 100 shown in FIG. 1C is the same as the DAS 100 shown in FIG. 1C except as described below. In the exemplary embodiment shown in FIG. 1D, the CPRI donor units 118, O-RAN donor unit 122, and master unit 130 are coupled to the RUs 106 and ICNs 112 via one or more RF units 114. That is, each RF unit 114 performs the transport frame multiplexing and demultiplexing that is described above in connection with FIG. 1C as being performed by the master unit 130.

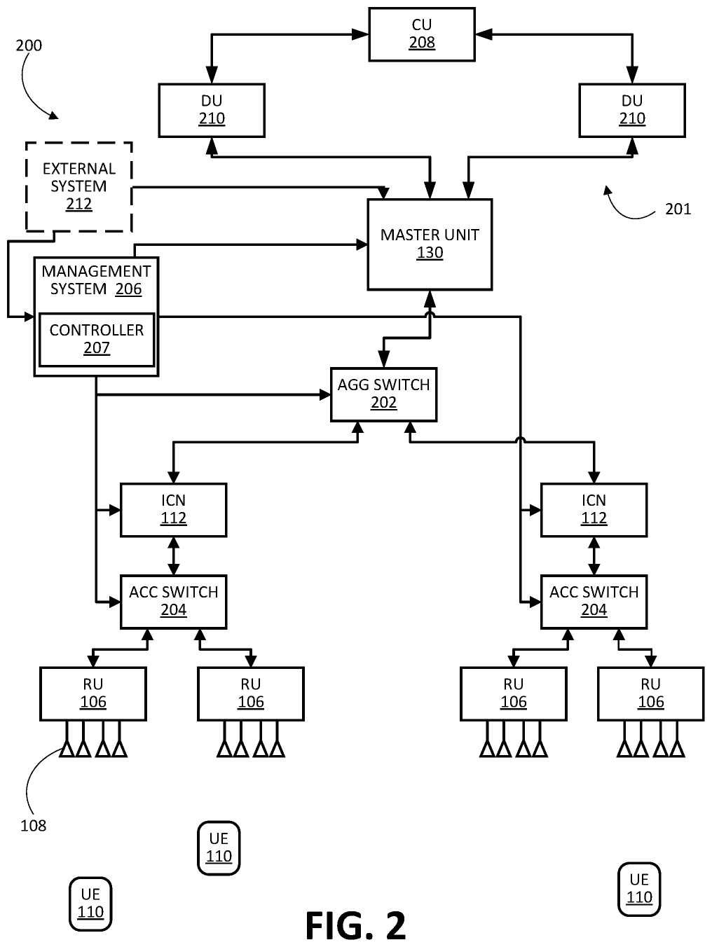

FIG. 2 illustrates another exemplary embodiment of a DAS 200. The DAS 200 shown in FIG. 2 includes similar components to the DAS 100 described above with respect to FIGS. 1A-1D. The functions, structures, and other description of common elements of the DAS 100 discussed above with respect to FIGS. 1A-1D are also applicable to like named features in the DAS 200 shown in FIG. 2. Further, the like named features included in FIGS. 1A-1D and 2 are numbered similarly. The description of FIG. 2 will focus on the differences from FIGS. 1A-1D.

In some examples, the DAS 200 is communicatively coupled to one or more base station entities 201. In the example shown in FIG. 2, the one or more base station entities 201 include one or more central units (CUs) 208 and one or more distributed units (DUs) 210. Each CU 208 is configured to implement Layer-3 and non-time critical Layer-2 functions for the associated base station. Each DU 210 is configured to implement the time critical Layer-2 functions and at least some of the Layer-1 (also referred to as the Physical Layer) functions for the associated base station. Each CU 208 can be further partitioned into one or more control-plane and user-plane entities that handle the control-plane and user-plane processing of the CU 208, respectively. Each such control-plane CU entity is also referred to as a “CU-CP,” and each such user-plane CU entity is also referred to as a “CU-UP.” In some examples, the RUs 106 are configured to implement the control-plane and user-plane Layer-1 functions not implemented by the DU 210 as well as the radio frequency (RF) functions. The RUs 106 are typically located remotely from the one or more base station entities 201. In the example shown in FIG. 2, the RUs 106 are implemented as a physical network function (PNF) and are deployed in or near a physical location where radio coverage is to be provided in the cell.

In this example, the DAS 200 is configured so that each DU 210 is configured to serve one or more RUs 106. In the particular configuration shown in FIG. 2, the two DUs 204 serve four RUs 106. Although FIG. 2 is described in the context of a 5G embodiment in which each logical base station entity is partitioned into a CU 208, DUs 210, and RUs 106 and some physical-layer processing is performed in the DU 210 with the remaining physical-layer processing being performed in the RUs 106, it is to be understood that the techniques described here can be used with other wireless interfaces (for example, 4G LTE) and with other ways of implementing a base station entity (for example, using a conventional baseband band unit (BBU)/remote radio head (RRH) architecture. Accordingly, references to a CU, DU, or RU with respect to FIG. 2 can also be considered to refer more generally to any entity (including, for example, any “base station” or “RAN” entity) implementing any of the functions or features described here as being implemented by a CU, DU, or RU.

The one or more base station entities 201 can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. For example, the scalable cloud environment is implemented in a distributed manner. That is, the scalable cloud environment is implemented as a distributed scalable cloud environment comprising at least one central cloud, at least one edge cloud, and at least one radio cloud.

In some examples, the DUs 210 are implemented as software virtualized entities that are executed in a scalable cloud environment on a cloud worker node under the control of the cloud native software executing on that cloud worker node. In such examples, the DUs 210 are communicatively coupled to at least one CU-CP and at least one CU-UP, which can also be implemented as software virtualized entities, and are omitted from FIG. 2 for clarity.

In some examples, each DU 210 is implemented as a single virtualized entity executing on a single cloud worker node. In some examples, the at least one CU-CP and the at least one CU-UP can each be implemented as a single virtualized entity executing on the same cloud worker node or as a single virtualized entity executing on a different cloud worker node. However, it is to be understood that different configurations and examples can be implemented in other ways. For example, the CU 208 can be implemented using multiple CU-UP VNFs and using multiple virtualized entities executing on one or more cloud worker nodes. In another example, multiple DUs 210 (using multiple virtualized entities executing on one or more cloud worker nodes) can be used to serve a cell, where each of the multiple DUs 210 serves a different set of RUs 106. Moreover, it is to be understood that the CU 208 and DUs 210 can be implemented in the same cloud (for example, together in the radio cloud or in an edge cloud). Other configurations and examples can be implemented in other ways.

In the example shown in FIG. 2, the RUs 106 are communicatively coupled to the DUs 210 via the master unit 130, and the master unit 130 is communicatively coupled to the RUs 106 via an aggregation switch 202 and two access switches 204 communicatively coupled to the aggregation switch 202. In the exemplary embodiment shown in FIG. 2, only uplink transport data is communicated using the ICNs 112, and downlink transport data is communicated from the master unit 130 to the RUs 106 without being forwarded by, or otherwise communicated using, the ICNs 112. In some configurations, each ICN 112 also forwards downlink transport data to the group of southbound RUs 106 and/or ICNs 112 served by that ICN 112.

The aggregation switch 202 and the access switches 204 can be implemented as physical switches or virtual switches running in a cloud (for example, a radio cloud). In some examples, the aggregation switch 202 and the access switches 204 are SDN capable and enabled switches. In some such examples, the aggregation switch 202 and the access switches 204 are OpenFlow capable and enabled switches. In such examples, the aggregation switch 202 and the access switches 204 are configured to distribute the downlink fronthaul data packets according to forwarding rules in respective flow tables and corresponding flow entries for each respective flow table.

In some examples, multicast addressing is used for transporting downlink data from the DU 210 to the RUs 106. This is done by defining groups of RUs 106, where each group is assigned a unique multicast IP address. The switches 202, 204 in the DAS 200 are configured to support forwarding downlink data packets using those multicast IP addresses. Each such group is also referred to here as a “multicast group.” The number of RUs 106 that are included in a multicast group is also referred to here as the “size” of the multicast group.

For downlink fronthaul traffic, the aggregation switch 202 is configured to receive downlink fronthaul data packets from the master unit 130 and distribute the downlink fronthaul data packets to the RUs 106 via the access switches 204. In some examples, the aggregation switch 202 receives a single copy of each downlink fronthaul data packet from the master unit 130 for each UE 110. In some examples, each copy is segmented into IP packets that have a destination address that is set to the address of the multicast group associated with that copy. The downlink fronthaul data packet is replicated and transmitted by the aggregation switch 202 and access switches 204 as needed to distribute the downlink fronthaul data packets to the RUs 106 for the particular respective UEs 110.

While the example shown in FIG. 2 shows a single CU 208, two DUs 210, a single master unit 130, a single aggregation switch 202, two ICNs 112, two access switches 204, and four RUs 106, it should be understood that this is an example and other numbers of base station CUs 208, DUs 210, master units 130, aggregation switches 202 (including zero), ICNs 112, access switches 204 (including one), and/or RUs 106 can also be used.

In the example shown in FIG. 2, the master unit 130, ICNs 112, aggregation switch 202, and the access switches 204 are also communicatively coupled to a management system 206. In the example shown in FIG. 2, the management system 206 is directly coupled to the master unit 130, the aggregation switch 202, the ICNs 112, and the access switches 204. It should be understood that other configurations could also be implemented. For example, the management system 206 can also be indirectly coupled to one or more components of the DAS 200 via another component of the DAS 200. The management system 206 can be implemented in a cloud (for example, a radio cloud, an edge cloud, or a central cloud) or in one of the appliances in, or coupled to, the radio access network (for example, in a Device Management System (DMS) or an Element Management System (EMS)). The management system 206 can include one or more controllers 207 configured to perform various functionality implemented by the management system 206. While not shown in FIGS. 1A-1D, it should be understood that the management system 206 as described herein can also be used in combination with the DAS 100 as described above with respect to FIGS. 1A-1D.

As discussed above, a 3GPP 5G network can provision one or more network slices to dedicate a share of the end-to-end resources for a particular use case or a particular operator/enterprise. The provisioning of network slices can occur dynamically (after initial deployment of the network) and/or statically (prior to deployment of the network) depending on the needs of the system. The techniques described below can be used to link and dedicate resources of the DAS to a particular network slice to ensure the same end-to-end performance when using a DAS to distribute the fronthaul signals for a network slice as when a DAS is not used.

In some examples, the management system 206 is configured to determine whether network slicing is activated for the signals provided to the DAS 200. In some such examples, the management system 206 is configured to manage both the base station entities 201 and the DAS 200, and the management system 206 would inherently be aware of the network slices provisioned in the RAN. In other examples, the management system 206 is configured to receive an indication from one or more external systems 212 (for example, core network) that provides information regarding the network slices provisioned in the RAN.

In some examples, the master unit 130 is configured to determine whether network slicing is activated for the signals provided to the DAS 200 in addition to (or instead of) the management system 206. In such examples, the master unit 130 is configured to monitor control-plane messages and determine whether the traffic is for a particular network slice. In some examples, the master unit 130 is configured to monitor control-plane messages for an identifier for the network slice. The identifier for the network slice (also referred to herein as the “network slice ID”) can include, but is not limited to, Single-Network Slice Selection Assistance Information (S-NSSAI), which contains a Slice/Service type (SST) and optionally a Service Differentiator (SD) that is used to differentiate amongst multiple network slices of the same Slice/Service type. In other examples, the master unit 130 is configured to receive an indication from one or more external systems 212 (for example, a core network) that provides information regarding the network slices provisioned in the RAN. In some examples, when the master unit 130 determines that a network slice is activated for signals provided to the DAS 200, the master unit 130 is configured to notify the management system 206.

In some examples, the management system 206 and/or the master unit 130 is configured to determine which distribution paths within the DAS 200 are impacted by the network slicing using location information for the DAS 200. In some examples, the location information includes the physical location of the master unit 130, ICNs 112, aggregation switch 202, access switches 204, and/or RUs 106 (or the hardware (for example, server or cloud infrastructure) used to implement the master unit 130, ICNs 112, aggregation switch 202, access switches 204, and/or RUs 106). In some examples, the management system 206 and/or the master unit 130 is configured to determine which distribution paths within the DAS 200 are impacted by the network slicing using band information and/or operator information. For example, the management system 206 and/or master unit 130 can determine the band information (for example, a band identifier such as a SEQ_ID) and/or operator information (for example, an operator identifier such as PC_ID) from a header of a data packet. In some examples, in addition to the location information for the DAS 200 and band information, the management system 206 and/or the master unit 130 determines the distribution paths within the DAS 200 that are impacted by the network slicing using characteristics associated with the traffic flows from the master unit 130 to the RUs 106. For example, IP addresses for a flow, port numbers for a flow, eCPRI port/stream/flow IDs, and the like can be used by the management system 206 and/or the master unit 130 and associated with the identifier for the network slice (for example, the network slice ID).

The management system 206 is also configured to receive an indication of available resources for the components of the DAS 200. In some examples, the master unit 130, ICNs 112, and/or RUs 106 are each configured to transmit information on their current available resources to the management system 206. The “available resources” of these nodes refers to the amount of processing resources (for example, CPU resources), memory, storage, and network resources that are currently available for the nodes. A node with more available resources will generally be able to support additional virtual network functions that are dedicated for network slicing. The management system 206 is also configured to receive available resources from the switches 202, 204 in the DAS 200. In some examples, the switches 202, 204 are each configured to transmit information on their current available resources to the management system 206. The “available resources” of the switches refers to the amount of network resources that are currently available for the switch. A switch with more available resources will generally be able to support traffic flows that are dedicated for network slicing.

In some examples, the master unit 130, ICNs 112, switches 202, 204, and/or RUs 106 are configured to periodically provide the indication of available resources to the management system 206. For example, the master unit 130, ICNs 112, switches 202, 204, and/or RUs 106 can be configured to provide the indication of available resources at regular time intervals to the management system 206. In some examples, the master unit 130, ICNs 112, switches 202, 204, and/or RUs 106 are configured to provide the indication of available resources in an on-demand manner. For example, the management system 206 can request the indication of available resources when a network slice is provisioned, when there is change in network conditions, etc. It should be understood that the master unit 130, ICNs 112, switches 202, 204, and/or RUs 106 can provide the indication of available resources periodically and on-demand, and the particular time intervals and factors for on-demand requests are configurable depending on the desired performance of the DAS 200.

The management system 206 is configured to dedicate resources of the DAS 200 to a network slice based on requirements for the network slice and the resource availability for components of the DAS 200 in an impacted distribution path. In some examples, dedicating resources of the DAS 200 to the network slice includes dedicating a sufficient amount processing resources (for example, CPU resources), memory, storage, and/or network resources for components of the DAS 200 to the network slice in order to meet the requirements (for example, SLA and QoS requirements) for the network slice. In some examples, the requirements for the network slice include parameters for throughput, bandwidth, latency, packet jitter, etc.

In some examples, the management system 206 is configured to dedicate resources of the DAS 200 by orchestrating and managing functions implemented by the one or more components of the DAS 200 based on the requirements for the network slicing and the available resources for the components of the DAS 200. For example, this can include determining the features of containerized network functions/virtualized network functions (CNFs/VNFs) for the components of the DAS 200 and the hardware requirements needed for instantiating one or more network functions dedicated to the network slice that meet the performance requirements for the network slice.

In some examples, the master unit 130 implements one or more containerized network functions (CNFs) configured to receive an input source from the DU 210 (for example, O-RAN source, CPRI source, RF source) and packetize the input to O-RAN or eCPRI compatible packets that are distributed via the DAS 200. In some examples, the management system 206 is configured to determine the type of CNF(s) to orchestrate for the master unit 130 for the network slice(s) and the physical hardware (for example, server) where the CNF(s) for the master unit 130 should be instantiated based on the requirements of the network slice(s) and the available resources for the master unit 130.

In some examples, the ICNs 112 implement one or more CNFs configured to perform uplink summing/combining of uplink signals received by the ICNs 112 from the RUs 106. In some examples, the CNF(s) dictate how summing/combining and noise reduction techniques will be performed at the ICN 112. In some examples, the management system 206 is configured to determine the type of CNF(s) to orchestrate for the ICNs 112 for the network slice(s) and the physical hardware (for example, server and amount of processing resources) where the CNF(s) for the ICNs 112 should be instantiated based on the requirements of the network slice(s) and the available resources for the ICN 112.

In some examples, the management system 206 is also configured to dedicate resources of the DAS 200 by dimensioning the transport network of the DAS 200 based on the requirements for the network slicing and the available resources for the components of the DAS 200 in an impacted distribution path. The dimensioning of the transport network of the DAS 200 can include, but is not limited to, setting Differentiated Services Code Point (DSCP) markings, adjusting buffer sizes, adjusting ports and the speed of the ports, VLAN tagging, adjusting the Type of Service (ToS) field in IPv4 and the Traffic class field in IPv6, and/or enabling/disabling compression for components of the DAS 200 in an impacted distribution path. By dimensioning the transport network of the DAS 200, the management system 206 can ensure that the transport network of the DAS 200 matches the end-to-end requirements for the network slice.

The management system 206 is configured to dedicate resources of the DAS 200 for network slices provisioned in the RAN by providing control signals to the one or more components of the DAS 200 to implement the determined actions discussed above. In some examples, the management system 206 provides instructions to the components of the DAS 200 in the impacted distribution path(s) to dedicate an amount of their available resources to a particular network slice. In some examples, the management system 206 provides control signals to the one or more components of the DAS 200 via out-of-band control messaging. For example, the management system 206 can provide the control signals to the one or more components of the DAS 200 using a management plane. It should be understood that the control signals from the management system 206 can be used to dedicated resources of one or more components of the DAS 200 for downlink operation, uplink operation, or both downlink operation and uplink operation.

In some examples, the management system 206 only transmits control signals to the master unit 130, ICNs 112, and switches 202, 204 when a change is needed based on the network slice and the impacted distribution path(s). In some examples, the management system 206 transmits the control signals only to the components of the DAS 200 that require changes to dedicate resources for the particular network slice. In other examples, the management system 206 broadcasts the updates to all of the components in the DAS 200, but only those components requiring change process the updates.

In some examples, the one or more controllers 207 of the management system 206 include an SDN controller, and the aggregation switch 202 and the access switches 204 are configured using the SDN controller. In such examples, the SDN controller can be configured to provide the updates (for example, to forwarding rules, buffers, etc.) for the aggregation switch 202 and/or the access switches 204 via the out-of-band control messaging.

Once the management system 206 completes the dedication of resources to a particular network slice, the components of the DAS 200 are configured to utilize the dedicated resources for signals corresponding to that network slice. In some examples, the components of the DAS 200 (for example, the master unit 130, ICNs 112, switches 202, 204, and RUs 106 in the impacted distribution path) are configured to utilize the resources dedicated to a particular network slice for signals having an identifier (for example, a network slice ID) for that network slice. In some examples, the master unit 130 monitors signals for the identifier for a particular network slice and routes the signals having the identifier for that network slice to the dedicated resources for that network slice. The dedicated resources for that network slice are used to process the signals for that network slice.

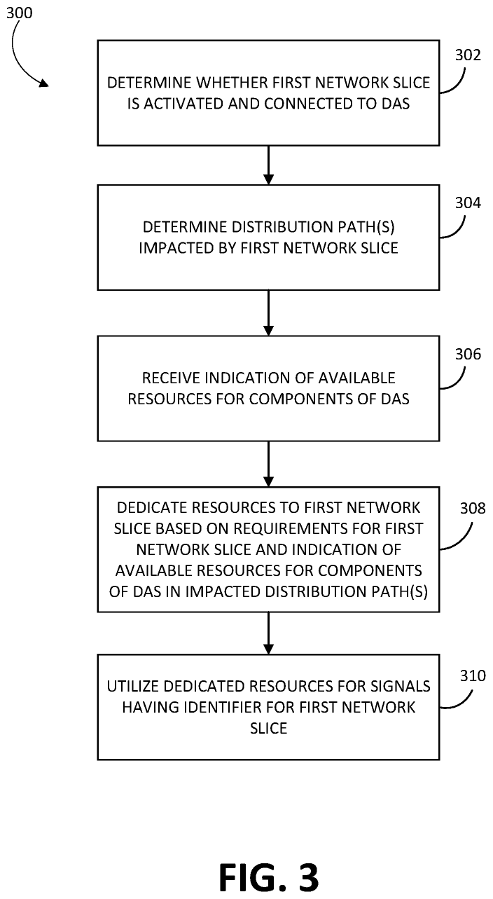

FIG. 3 illustrates a flow diagram of an example method 300 for supporting network slicing in a DAS. The common features discussed above with respect to the DAS 200 in FIG. 2 can include similar characteristics to those discussed with respect to method 300 and vice versa.

The blocks of the flow diagram in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel in an event-driven manner).

The method 300 includes determining whether a first network slice is activated and connected to the DAS (block 302). In some examples, a master unit of the DAS is configured to determine whether a first network slice is activated by monitoring control messages for an identifier for the network slice. The identifier for the network slice (also referred to herein as the “network slice ID”) can include, but is not limited to, Single-Network Slice Selection Assistance Information (S-NSSAI), which contains a Slice/Service type (SST) and optionally a Service Differentiator (SD) that is used to differentiate amongst multiple network slices of the same Slice/Service type. In some examples, in addition to (or instead of) the master unit monitoring control messages, a management system and/or the master unit is configured to receive an indication from an external system (for example, the core network) that provides information regarding the active network slices for signals provided to the DAS. In other examples, the management system is configured to manage both the base station entities and the DAS, so the management system is aware of the active network slices for signals provided to the DAS.

The method 300 further includes determining one or more distribution paths impacted by the first network slice (block 304). In some examples, the master unit of the DAS and/or the management system is configured to determine the distribution paths impacted by the network slicing using topology and location information for the DAS and characteristics of traffic flows from the master unit to the RUs.

The method 300 further includes receiving an indication of available resources for components of the DAS (block 306). In some examples, the components of the DAS are configured to provide resources availability information to the management system periodically (for example, at regular time intervals) and/or on-demand (for example, when requested by the management system). The “available resources” for components of the DAS can include, but is not limited to, an amount of processing resources (for example, CPU resources), memory, storage, and network resources that are currently available for the components of the DAS.

The method 300 further includes dedicating resources to the first network slice based on requirements for the first network slice and the indication of available resources for the components of the DAS in the impacted distribution path(s) (block 308). In some examples, dedicating resources to the first network slice includes orchestrating and managing network functions and dimensioning the transport network for components of the DAS in the impacted distribution path(s) to support the requirements for the first network slice. In some examples, the management system provides control signals to the one or more components of the DAS in the impacted distribution path(s) to dedicate an amount of available resources to the first network slice.

The method 300 further includes utilizing the dedicated resources of the DAS dedicated to the first network slice for signals having an identifier for the first network slice (block 310). In some examples, the master unit is configured to monitor signals for the identifier (for example, network slice ID) of the first network slice route the signals having the identifier for the first network slice to the dedicated resources for the first network slice. The dedicated resources for the first network slice are used to process the signals having the identifier for the first network slice.

Similar steps to those described above for method 300 can be repeated for any number of network slices that are to be served by the DAS in order to dedicate resources of the DAS to those network slices. Using the techniques described herein, a system can ensure that the end-to-end QoS and SLA requirements for the network slices can be met even when using a DAS for distribution of fronthaul signals.

As discussed above, a 3GPP 5G private network can be provisioned in combination with a public network and share common infrastructure (for example, a DAS) with the public network. In some examples, one or more network slices of a public network can be provisioned and allocated to support a private network. In such examples, the techniques described above with respect to FIGS. 2-3 can be used to support the private network when used in combination with a DAS.

In other examples where a private network does not utilize a network slice of a public network (for example, where the private network is a separate public land mobile network (PLMN)), alternative techniques are needed to ensure the same end-to-end performance when using a DAS to distribute the fronthaul signals for a private network as when a DAS is not used. The techniques described below can be used to link and manage DAS resources for a private network as well as the core network and base station entities for the private network in some examples.

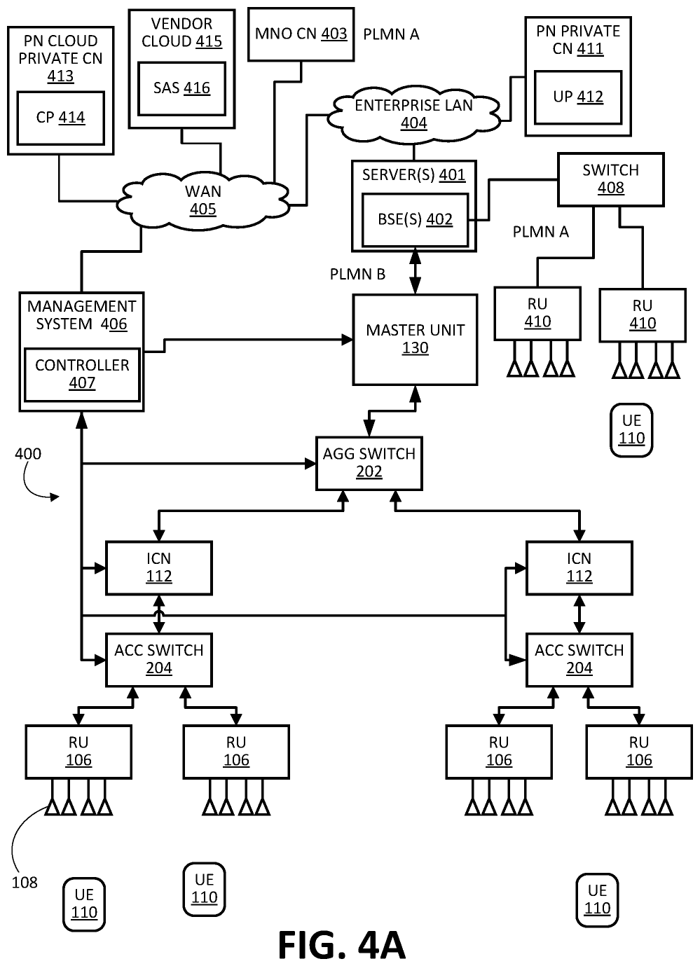

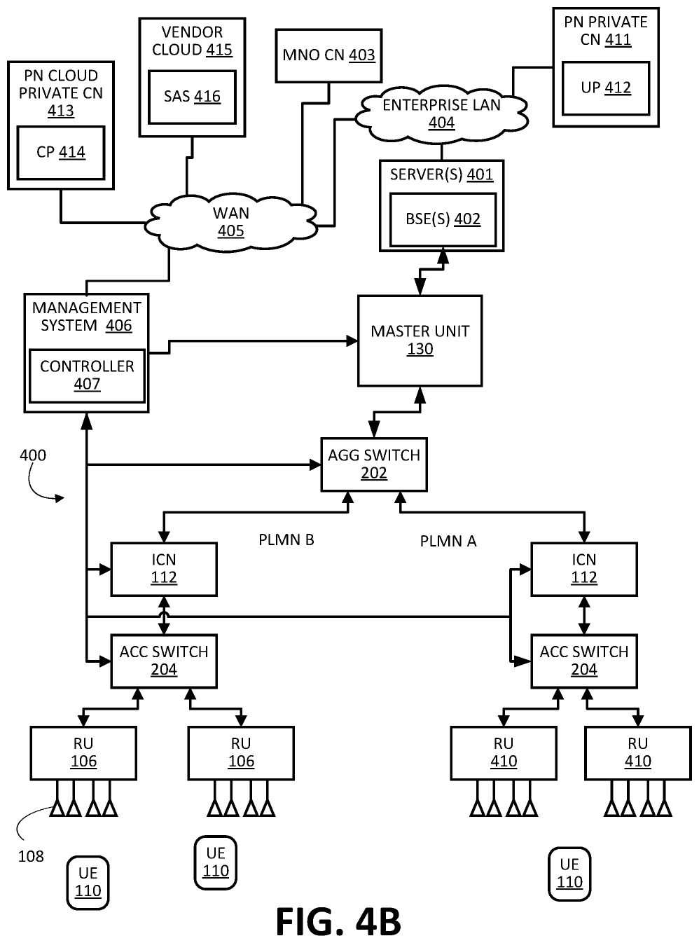

FIG. 4A illustrates another exemplary embodiment of a DAS 400. The DAS 400 shown in FIG. 4A includes similar components to the DAS 200 described above with respect to FIG. 2. The functions, structures, and other description of common elements of the DAS 200 discussed above with respect to FIG. 2 are also applicable to like named features in the DAS 400 shown in FIG. 4A. Further, the like-named features included in FIGS. 2 and 4A are numbered similarly. The description of FIG. 4A will focus on the differences from FIG. 2.

In the example shown in FIG. 4A, the DAS 400 is communicatively coupled to one or more base station entities 402 for a private network that shares some common infrastructure with another PLMN. In the example shown in FIG. 4A, a first PLMN (PLMN A) shares some common infrastructure with a second PLMN (PLMN B), and the DAS 400 is communicatively coupled to base station entities 402 for PLMN B. In the example shown in FIG. 4A, PLMN A is a public network and PLMN B is a private network that is served by the DAS 400. In some examples, the private network is deployed by a private enterprise at a site associated with the enterprise. As used here, a “private enterprise” refers to any organization (such as a for-profit, non-profit, or governmental corporation, company, or other corporate or governmental entity) the primary purpose of which is something other than providing wireless service to customers, members, or other stakeholders of the organization.

In the example shown in FIG. 4A, one or more base station entities 402 for each of the PLMNs are instantiated on one or more servers 401. The one or more base station entities 402 include one or more central units (CUs) and one or more distributed units (DUs). Each CU implements Layer-3 and non-time critical Layer-2 functions for the associated base station and PLMN. Each DU is configured to implement the time critical Layer-2 functions and at least some of the Layer-1 (also referred to as the Physical Layer) functions for the associated base station and PLMN. Each CU can be further partitioned into one or more control-plane and user-plane entities that handle the control-plane and user-plane processing of the CU, respectively. Each such control-plane CU entity is also referred to as a “CU-CP,” and each such user-plane CU entity is also referred to as a “CU-UP.”

In this example, the DAS 400 is configured so that each DU for PLMN B is configured to serve one or more RUs 106. Although FIG. 4A is described in the context of a 5G embodiment in which each logical base station entity is partitioned into a CU, DUs, and RUs and some physical-layer processing is performed in the DU with the remaining physical-layer processing being performed in the RUs, it is to be understood that the techniques described here can be used with other wireless interfaces (for example, 4G LTE) and with other ways of implementing a base station entity (for example, using a conventional baseband band unit (BBU)/remote radio head (RRH) architecture. Accordingly, references to a CU, DU, or RU with respect to FIG. 4A can also be considered to refer more generally to any entity (including, for example, any “base station” or “RAN” entity) implementing any of the functions or features described here as being implemented by a CU, DU, or RU.

The one or more base station entities 402 can be implemented as software virtualized entities that are executed in a scalable cloud environment in a similar manner as that discussed above with respect to the base station entities 201 in FIG. 2. In the example shown in FIG. 4A, the RUs 410 for PLMN A are communicatively coupled to the base station entities 402 for PLMN A via a switch 408, which can be implemented as a physical switch or as a virtual switch running in a cloud (for example, a radio cloud). In some examples, the

RUs 410 are configured to implement the control-plane and user-plane Layer-1 functions not implemented by the DU as well as the radio frequency (RF) functions for PLMN A. The RUs 410 are typically located remotely from the one or more base station entities 402. In the example shown in FIG. 4A, the RUs 410 are implemented as a physical network function (PNF) and are deployed in or near a physical location where radio coverage is to be provided for PLMN A.

In the example shown in FIG. 4A, the RUs 106 for PLMN B are part of the DAS 400 and communicatively coupled to the base station entities 402 for PLMN B via the master unit 130, aggregation switch 202, ICNs 112, and access switches 204. In some examples, the RUs 106 are configured to implement the control-plane and user-plane Layer-1 functions not implemented by the DU as well as the radio frequency (RF) functions for PLMN B. The RUs 106 are typically located remotely from the one or more base station entities 402 for PLMN

B. In the example shown in FIG. 4A, the RUs 106 are implemented as a physical network function (PNF) and are deployed in or near a physical location where radio coverage is to be provided for PLMN B.

In the example shown in FIG. 4A, the base station entities 402 for PLMN A are configured to wirelessly communicate with one or more UEs 110 using the licensed RF spectrum licensed to PLMN A. In the example shown in FIG. 4A, each CU of the base station entities 402 for PLMN A is configured to communicate with the mobility network operator (MNO) core network 403 for PLMN A using an appropriate backhaul network (for example, a public wide area network 405 such as the Internet).

In the example shown in FIG. 4A, the private network (PLMN B) includes a dedicated private core network. In the example shown in FIG. 4A, a portion of the private core network 411 is deployed at the site to provide user-plane core network functionality (labeled “UP 412”) for the underlying one or more wireless access protocols (such as 4G LTE and 5G NR) used by the DAS 400 to wirelessly communicate with the UEs 110. In some examples, the user-plane functionality implemented in the portion of the private core network 411 includes one or more User Plane Functions (UPFs). Also, at least a portion of the private core network (labeled “CP 414” in FIG. 4A) is deployed in the cloud 413 to provide required control-plane core network functionality for the underlying one or more wireless access protocols (such as 4G LTE and 5G NR) used by the DAS 400 to wirelessly communicate with the UEs 110. In the example shown in FIG. 4A, the control-plane (CP) functionality 414 of the private core network is implemented in the cloud 413 whereas the user-plane (UP) functionality 412 is implemented locally at the site. It should be understood that other implementations could also be used depending on the requirements of the private network and the available resources.

In some examples, the private network (PLMN B) supports the use of the Citizens Broadband Radio Spectrum (CBRS). In such examples, the private network can include one or more Citizens Broadband Radio Service Devices (CBSDs) (also referred to as “CBRS access points”) configured to use the Citizens Broadband Radio Spectrum and one or more wireless access protocols (such as 4G LTE and 5G NR) to provide wireless connectivity to one or more of the UEs 110. In such examples, the private network is configured to interact with a spectrum access system (SAS) 416, which in turn is configured to interact with an Environmental Sensing Capability (ESC) (not shown) and to dynamically manage access to the Citizens Broadband Radio Spectrum in accordance with the relevant regulations and protocols promulgated for using the Citizens Broadband Radio Spectrum. In the embodiment shown in FIG. 4A, the SAS 416 is deployed and managed by the vendor of the SAS 416 in a respective cloud 415 (for example, in a vendor cloud 415) (though it is to be understood that the SAS 416 can be deployed in a different cloud). The CBSDs are configured to access the SAS 416 via the enterprise local area network 404 deployed at the site (to which some components of the DAS 400 are connected via a wired connection) and the public wide area network 405 (for example, the Internet).

In some examples, the private network (PLMN B) supports, in addition to or instead of the use CBRS, the use of licensed RF spectrum that is dedicated to providing 4G LTE and/or 5G NR wireless service (for example, using the licensed RF spectrum licensed to a public wireless service operator). For example, the base station entities 402 for the private network can include at least one 5G NR base station (which is also referred to as a “gNodeB” or “gNB”).

In the example shown in FIG. 4A, the management system 406 is communicatively coupled to the components of the DAS 400 in a manner similar to that shown and described above with respect to FIG. 2. In the example shown in FIG. 4A, the management system 406 is also communicatively coupled to the dedicated private core network and the base station entities via the public wide area network 405 and local area network 404. In some examples, the management system 406 is configured to manage/orchestrate the core network entities in the dedicated private core network and the base station entities for the private network in addition to the components of the DAS 400. While not shown in FIGS. 1A-1D, it should be understood that the management system 406 as described herein can also be used in combination with the DAS 100 as described above with respect to FIGS. 1A-1D.

In some examples, the management system 406 is configured to determine whether a private network is activated and connected to the DAS 400. In some such examples, the management system 406 is configured to manage both the base station entities 402 and the DAS 400, and the management system 406 is inherently aware of the private networks provisioned along with the configurations.

In some examples, the management system 406 is configured to determine which distribution paths within the DAS 400 are impacted by the private network using known PLMN information for the private network (for example, PLMN identifier). In some examples, the management system 406 is configured to determine which distribution paths within the DAS 400 are impacted by the private network using location information for the DAS 400. In some examples, the location information includes the physical location of the master unit 130, ICNs 112, aggregation switch 202, access switches 204, and/or RUs 106 (or the hardware (for example, server or cloud infrastructure) used to implement the master unit 130, ICNs 112, aggregation switch 202, access switches 204, and/or RUs 106). In some examples, in addition to the PLMN and location information, the management system 406 determines the distribution paths within the DAS 400 that are impacted by the private network using characteristics associated with the traffic flows from the master unit 130 to the RUs 106. For example, IP addresses for a flow, port numbers for a flow, eCPRI port/stream/flow IDs, and the like can be used by the management system 406 and associated with the identifier for the private network (for example, the PLMN identifier). There will most likely be several distribution paths within the DAS 400 that are impacted by the private network. In some examples, all of the distribution paths within the DAS 400 that are impacted by the private network can be associated with a DAS slice identifier associated with or corresponding to the PLMN identifier for the private network in the management system 406. In some examples, the DAS slice identifier is used by the DAS 400 in a manner similar to the network slice identifier discussed above with respect to FIGS. 2-3 in order to route traffic for the private network.

The management system 406 is also configured to receive an indication of available resources for the components of the DAS 400. In some examples, the master unit 130, ICNs 112, and/or RUs 106 are each configured to transmit information on their current available resources to the management system 406. The “available resources” of these nodes refers to the amount of processing resources (for example, CPU resources), memory, storage, and network resources that are currently available for the nodes. A node with more available resources will generally be able to support additional virtual network functions that are dedicated for network slicing. The management system 406 is also configured to receive available resources from the switches 202, 204 in the DAS 400. In some examples, the switches 202, 204 are each configured to transmit information on their current available resources to the management system 406. The “available resources” of the switches refers to the amount of network resources that are currently available for the switch. A switch with more available resources will generally be able to support traffic flows that are dedicated for network slicing.

In some examples, the management system 406 is also configured to receive capability information for the nodes of the DAS 400. In some examples, the master unit 130, ICNs 112, and/or RUs 106 are each configured to transmit capability information for performing RAN functions to the management system 406. The “capability information” of these nodes refers to the parameters that characterize the capability of the nodes to perform RAN functions and/or a type of node (for example, model number), which can be used to determine the RAN functions that can be performed by a type of node.

In some examples, the master unit 130, ICNs 112, switches 202, 204, and/or RUs 106 are configured to periodically provide the indication of available resources and capability information to the management system 406. For example, the master unit 130, ICNs 112, switches 202, 204, and/or RUs 106 can be configured to provide the indication of available resources and capability information at regular time intervals to the management system 406.

In some examples, the master unit 130, ICNs 112, switches 202, 204, and/or RUs 106 are configured to provide the indication of available resources and capability information in an on-demand manner. For example, the management system 406 can request the indication of available resources and capability information when a private network is provisioned, when there is change in network conditions, etc. It should be understood that the master unit 130, ICNs 112, switches 202, 204, and/or RUs 106 can provide the indication of available resources and capability information periodically and on-demand, and the particular time intervals and factors for on-demand requests are configurable depending on the desired performance of the DAS 400.

In some examples, the management system 406 is configured to determine one or more split options to enable for the private network. In some examples, the determination of the split option(s) to enable is based on the requirements for the private network, the resource availability for components of the DAS 400 in the impacted distribution path(s), and the capability information for the nodes of the DAS 400. For example, the management system 406 can only enable Split Option 6 for a distribution path if the components of the DAS 400 in the path (for example, master unit 130, ICN 112, and RUs 106) have sufficient available resources and capability to perform all of the Layer-1 functions as well as the radio frequency (RF) functions.

In some examples, the management system 406 is configured to determine locations for core network entities and base station entities for the private network based on requirements for the private network and location of the master unit 130 (and potentially other nodes of the DAS 400). In some examples, the determination of the location for the private core network entities and/or the base station entities for the private network is based on latency requirements for the private network, and the management system 406 is configured to place the containerized network functions/virtualized network functions (CNFs/VNFs) for the UPF, the CU-UP, and/or the DU as close as possible to the master unit 130 (or at least the network that includes the master unit 130) to minimize latency for user-plane data for the private network. In some examples, the management system 406 is configured to dynamically select and/or dynamically instantiate instances of the CNFs/VNFs for the UPF, the CU-UP, and/or the DU based on the requirements for the private network.

In some examples, the management system 406 is configured to determine the locations for core network entities and base station entities for the private network based on the split options that are enabled and available resources for the DAS nodes. In some examples where a split option is enabled for the private network where a greater amount of Layer-1 processing is performed by the DU (for example, Split Option 8), the core network and base station entities for the private network can be instantiated on the same server as the master unit 130. For example, the DU can be instantiated on the same server as the master unit 130 and possibly the UPF as well if sufficient resources are available. In other examples where a split option is enabled for the private network where a lesser amount of Layer-processing is performed by the DU (for example, Split Option 7.2 or 6), the core network and base station entities for the private network may not be able to be located past a particular point in the user-plane path depending on where the RAN functions are distributed in the DAS 400.

The management system 406 is configured to dedicate resources of the DAS 400 to a private network based on requirements for the private network and the resource availability for components of the DAS 400 in an impacted distribution path. In some examples, dedicating resources of the DAS 400 to the private network includes dedicating a sufficient amount processing resources (for example, CPU resources), memory, storage, and/or network resources for components of the DAS 400 to the private network in order to meet the requirements (for example, SLA and QoS requirements) for the private network. In some examples, the requirements for the private network include parameters for throughput, bandwidth, latency, packet jitter, etc.

In some examples, the management system 406 is configured to dedicate resources of the DAS 400 by orchestrating and managing functions implemented by the one or more components of the DAS 400 based on the requirements for the private network and the available resources for the components of the DAS 400. For example, this can include determining the features of the containerized network functions/virtualized network functions (CNFs/VNFs) and the hardware requirements needed for instantiating one or more network functions dedicated to the private network that meet the performance requirements for the private network.

In some examples, the master unit 130 implements one or more CNFs configured to receive an input source from the DU (for example, O-RAN source, CPRI source, RF source) and packetize the input to O-RAN or eCPRI compatible packets that are distributed via the DAS 400. In some examples, the management system 406 is configured to determine the type of CNF(s) to orchestrate for the master unit 130 for the private network and the physical hardware (for example, server) where the CNF(s) for the master unit 130 should be instantiated based on the requirements of the private network and the available resources for the master unit 130.

In some examples, the ICNs 112 implement one or more CNFs configured to perform uplink summing/combining of uplink signals received by the ICNs 112 from the RUs 106. In some examples, the CNF(s) dictate how summing/combining and noise reduction techniques will be performed at the ICN 112. In some examples, the management system 406 is configured to determine the type of CNF(s) to orchestrate for the ICNs 112 for the private network and the physical hardware (for example, server and amount of processing resources) where the CNF(s) for the ICNs 112 should be instantiated based on the requirements of the private network and the available resources for the ICN 112.

In some examples, the management system 406 is also configured to dedicate resources of the DAS 400 by dimensioning the transport network of the DAS 400 based on the requirements for the private network and the available resources for the components of the DAS 400 in an impacted distribution path. The dimensioning of the transport network of the DAS 400 can include, but is not limited to, setting Differentiated Services Code Point (DSCP) markings, adjusting buffer sizes, adjusting ports and the speed of the ports, VLAN tagging, adjusting the Type of Service (ToS) filed in IPv4 and the Traffic class field in IPv6, and/or enabling/disabling compression for components of the DAS 400 in an impacted distribution path. By dimensioning the transport network of the DAS 400, the management system 406 can ensure that the transport network of the DAS 400 matches the end-to-end requirements for the private network.

The management system 406 is configured to dedicate resources of the DAS 400 for the private network by providing control signals to the one or more components of the DAS 400 to implement the determined actions discussed above. In some examples, the management system 406 provides instructions or control signals to the components of the DAS 400 in a manner similar to that described above with respect to the management system 206 shown in FIG. 2.

Once the management system 406 completes the dedication of resources of the DAS 400 to a particular private network (and the determinations regarding the split option(s) and the location of the core network and base station entities in some examples), the components of the private core network, base station entities 402, and components of the DAS 400 are utilized for the private network. In the example shown in FIG. 4A, one or more base station entities 402 (for example, the DU) for the private network are configured to monitor signals for the identifier for that private network and route the signals having the identifier for that private network to the DAS 400. In some examples, the one or more base station entities 402 modify the data packets sent to the master unit 130 to include a DAS slice identifier associated with the PLMN identifier of the private network and the resources of the DAS 400 that are dedicated to the private network. In some examples, the components of the DAS 400 (for example, the master unit 130, ICNs 112, switches 202, 204, and RUs 106 in the impacted distribution path) are configured to utilize the resources dedicated to a particular private network for signals having the DAS slice identifier corresponding to that private network. In some examples, the master unit 130 monitors signals for the DAS slice identifier corresponding to the private network and routes the signals having the DAS slice identifier for the private network to the dedicated resources for that private network. The resources of the DAS 400 dedicated to the private network are used to process the signals for that private network.

FIG. 4B illustrates another exemplary embodiment of a DAS 400. The DAS 400 shown in FIG. 4B includes similar components to the DAS 400 described above with respect to FIG. 4A. The functions, structures, and other description of common elements of the DAS 400 discussed above with respect to FIG. 4A are also applicable to like named features in the DAS 400 shown in FIG. 4B. Further, the like-named features included in FIGS. 4A and 4B are numbered similarly. The description of FIG. 4B will focus on the differences from FIG. 4A.

In the example shown in FIG. 4B, the MNO (PLMN A) and the private network (PLMN B) both utilize components of the DAS 400 for distribution of fronthaul signals. In addition to the functions discussed above with respect to FIG. 4A, the management system 406 in FIG. 4B also configures a subset of the components of the DAS 400 to serve the MNO (PLMN A). In particular, the management system 406 configures the components of the DAS 400 so the MNO uses distribution paths of the DAS 400 associated with the RUs 410 and the private network uses distribution paths of the DAS 400 associated with the RUs 106.

In the example shown in FIG. 4B, respective base station entities 402 for the MNO and private network are communicatively coupled to the master unit 130 and communicate signals for the MNO and the private network to/from the master unit 130. In some examples, the one or more base station entities 402 for the private network modify the data packets sent to the master unit 130 to include the DAS slice identifier associated with the PLMN identifier of the private network and the resources of the DAS 400 dedicated to the private network.

In some examples, the components of the DAS 400 (for example, the master unit 130, ICNs 112, switches 202, 204, and RUs 106 in the impacted distribution path) are configured to utilize the resources dedicated to the private network for signals having the DAS slice identifier corresponding to the private network. In some examples, the master unit 130 monitors signals for the DAS slice identifier corresponding to the private network and processes/routes the signals having the DAS slice identifier for the private network using the dedicated resources for that private network. In some examples, the master unit 130 routes the signals not having the DAS slice identifier for the private network (for example, traffic for the MNO) to the resources of the DAS 400 that are not dedicated to the private network. For example, the master unit 130 is configured to route the signals with the DAS slice identifier to the distribution paths for the RUs 106 and to route the signals not having the DAS slice identifier to the distribution paths for the RUs 410.

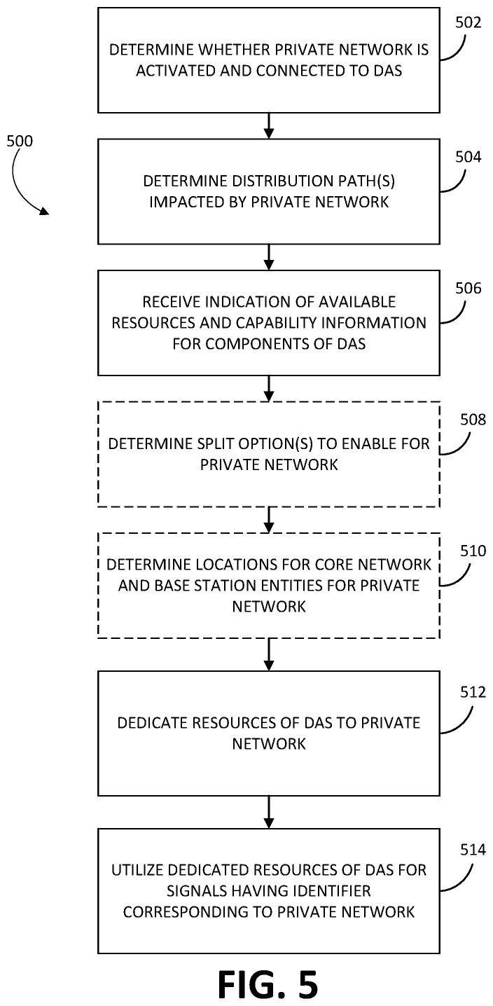

FIG. 5 illustrates a flow diagram of an example method 500 for supporting a private network using a DAS. The common features discussed above with respect to the DAS 400 in FIGS. 4A-4B can include similar characteristics to those discussed with respect to method 500 and vice versa.

The blocks of the flow diagram in FIG. 5 have been arranged in a generally sequential manner for ease of explanation; however, it is to be understood that this arrangement is merely exemplary, and it should be recognized that the processing associated with method 500 (and the blocks shown in FIG. 5) can occur in a different order (for example, where at least some of the processing associated with the blocks is performed in parallel in an event-driven manner).

The method 500 includes determining whether a private network is activated and connected to the DAS (block 502). In some examples, a management system is configured to manage both the base station entities and the DAS for a private network, so the management system is aware of the active private networks providing signals to the DAS.

The method 500 further includes determining one or more distribution paths impacted by the private network (block 504). In some examples, the management system is configured to determine the distribution paths impacted by the private network using PLMN information, topology and location information for the DAS, and characteristics of traffic flows from the master unit to the RUs.

The method 500 further includes receiving an indication of available resources capability information for components of the DAS (block 506). In some examples, the components of the DAS are configured to provide resource availability information and capability information to the management system periodically (for example, at regular time intervals) and/or on-demand (for example, when requested by the management system). The “available resources” for components of the DAS can include, but is not limited to, an amount of processing resources (for example, CPU resources), memory, storage, and network resources that are currently available for the components of the DAS. The “capability information” of the DAS nodes can include, but is not limited to, parameters that characterize the capability of the nodes to perform RAN functions and/or a type of node (for example, model number).

The method 500 optionally includes determining split options to enable for the private network (block 508). In some examples, the management system is configured to determine the split options to enable based on the requirements for the private network and the indication of available resources and capability information for the components of the DAS in the impacted distribution path(s).

The method 500 optionally includes determining locations for core network entities and base station entities for the private network (block 510). In some examples, the management system is configured to determine the locations for the core network entities and the base station entities for the private network based on the requirements for the private network and the location of the master unit of the DAS. In some such examples, the management system is configured to instantiate one or more core network entities (for example, the UPF) and/or one or more base station entities (for example, the DU) to be close to the master unit in order to reduce latency for user-plane data. In some examples, the locations for core network entities and base station entities for the private network are also determined based on the split options enabled for the private network and the available resources for the DAS nodes.

The method 500 further includes dedicating resources of the DAS to the private network (block 512). In some examples, the management system is configured to dedicate the resources of the DAS based on requirements for the private network and the indication of available resources for the components of the DAS in the impacted distribution path(s). In some examples, dedicating resources to the private network includes orchestrating and managing network functions and dimensioning the transport network for components of the DAS in the impacted distribution path(s) to support the requirements for the private network. In some examples, the management system provides control signals to the one or more components of the DAS in the impacted distribution path(s) to dedicate an amount of available resources to the private network.

The method 500 further includes utilizing the resources of the DAS dedicated to the private network for signals having an identifier that corresponds to the private network (block 514). In some examples, the one or more base station entities are configured to monitor signals for an identifier associated with the PLMN (for example, PLMN code) for the private network and route the signals having the identifier associated with the PLMN for the private network to the dedicated resources for the private network. In some examples, the one or more base station entities are configured to route the signals based on one or more additional parameters, such as, for example, band class, location, and split option. In some examples, the one or more base station entities are configured to include a DAS slice identifier in the data packets for the private network that is associated with the PLMN of the private network and the dedicated resources of the DAS. The master unit can use the DAS slice identifier for internal processing and routing of the signals for the private network.

Similar steps to those described above for method 500 can be repeated for any number of private networks that are to be served by the DAS for managing and dedicating resources of the DAS to those private networks. Using the techniques described herein, a system can ensure that the end-to-end QoS and SLA requirements for the private networks can be met even when using a DAS for distribution of fronthaul signals.

Furthermore, the techniques described with respect to network slicing and private networks can both be utilized in combination for a single DAS to enable the DAS to ensure that the end-to-end QoS and SLA requirements for network slices and private networks can be met even when using a DAS for distribution of fronthaul signals.

### EXAMPLE EMBODIMENTS

Example 1 includes a method for supporting a private network with a distributed antenna system, the method comprising: determining whether a private network is activated and connected to the distributed antenna system; determining one or more paths of the distributed antenna system impacted by the private network; receiving an indication of available resources and capability information for one or more components in the distributed antenna system; dedicating resources of the distributed antenna system to the private network based on requirements of the private network and the available resources for the one or more components of the distributed antenna system; and utilizing the resources of the distributed antenna system dedicated to the private network for traffic having an identifier corresponding to the private network.

Example 2 includes the method of Example 1, wherein determining one or more paths of the distributed antenna system impacted by the private network is based on Public Land Mobile Network (PLMN) information for the private network, topology information for the distributed antenna system, location information for nodes of the distributed antenna system, and/or characteristics of one or more flows supported by the distributed antenna system.

Example 3 includes the method of any of Examples 1-2, further comprising determining a location for one or more core network entities and one or more base station entities for the private network that will reduce latency for user-plane data for the private network.

Example 4 includes the method of Example 3, wherein determining the location for one or more core network entities and the one or more base station entities for the private network includes: determining a location for one or more user plane functions (UPFs) for the private network; determining a location for one or more central units (CUs) for the private network; and/or determining a location for one or more distributed units (DUs) for the private network.

Example 5 includes the method of any of Examples 1-4, further comprising determining one or more split options to enable for the private network based on the requirements of the private network, the indication of available resources for the one or more components of the distributed antenna system, and the capability information for the one or more components of the distributed antenna system.

Example 6 includes the method of any of Examples 1-5, wherein the distributed antenna system includes a master unit communicatively coupled to and located remotely from a plurality of radio units, wherein the master unit is communicatively coupled to the plurality of radio units via one or more switches and one or more intermediary combining nodes.

Example 7 includes the method of Example 6, wherein dedicating resources of the distributed antenna system to the private network based on the requirements of the private network and the available resources for the one or more components of the distributed antenna system includes: instantiating one or more network functions for the private network at the master unit and/or at the one or more intermediary combining nodes; selecting physical hardware to instantiate the one or more network functions for the private network; and/or determining dimensioning of a transport network of the distributed antenna system for the one or more switches to support the requirements for the private network.

Example 8 includes the method of any of Examples 6-7, wherein dedicating resources of the distributed antenna system to the private network based on requirements of the private network and the available resources for the one or more components of the distributed antenna system includes: dedicating processing resources, memory, storage, and/or network resources of the master unit, the one or more intermediary combining nodes, and the plurality of radio units to the private network; and dedicating network resources of the one or more switches to the private network.

Example 9 includes the method of any of Examples 1-8, wherein dedicating resources of the distributed antenna system to the private network based on the requirements of the private network and the available resources for the one or more components of the distributed antenna system includes associating a Public Land Mobile Network (PLMN) identifier of the private network with the resources of the distributed antenna system dedicated to the private network; wherein utilizing the resources of the distributed antenna system dedicated to the private network for traffic having an identifier corresponding to the private network includes routing traffic that includes an identifier corresponding to the PLMN identifier of the private network to the resources of the distributed antenna system dedicated to the private network.

Example 10 includes a system, comprising: a master unit of a distributed antenna system, wherein the master unit is configured to be coupled to one or more base station entities of a private network; a plurality of radio units of the distributed antenna system communicatively coupled to the master unit, wherein the plurality of radio units is located remotely from the master unit; and at least one controller communicatively coupled to the master unit, wherein the at least one controller is configured to: determine whether the private network is activated and connected to the distributed antenna system; determine one or more paths of the distributed antenna system impacted by the private network; receive an indication of available resources and capability information for one or more components in the distributed antenna system; and dedicate resources of the distributed antenna system to the private network based on requirements of the private network and the available resources for the one or more components of the distributed antenna system; wherein the system is configured to utilize the resources of the distributed antenna system dedicated to the private network for traffic having an identifier corresponding to the private network.

Example 11 includes the system of Example 10, wherein the at least one controller is further configured to determine a location for one or more core network entities and the one or more base station entities for the private network that will reduce latency for user-plane data for the private network.

Example 12 includes the system of Example 11, wherein the at least one controller is configured to: determine a location for one or more user plane functions (UPFs) for the private network; determine a location for one or more central units (CUs) for the private network; and/or determine a location for one or more distributed units (DUs) for the private network.

Example 13 includes the system of any of Examples 10-12, wherein the at least one controller is further configured to determine one or more split options to enable for the private network based on the requirements of the private network, the indication of available resources for the one or more components of the distributed antenna system, and the capability information for the one or more components of the distributed antenna system.

Example 14 includes the system of any of Examples 10-13, wherein the at least one controller is configured to determine the one or more paths of the distributed antenna system impacted by the private network includes using topology information for the distributed antenna system, location information for nodes of the distributed antenna system, and characteristics of one or more flows supported by the distributed antenna system.

Example 15 includes the system of any of Examples 10-14, wherein the master unit is communicatively coupled to the plurality of radio units via one or more switches and one or more intermediary combining nodes.

Example 16 includes the system of Example 15, wherein the at least one controller is configured to dedicate resources of the distributed antenna system to the private network based on requirements of the private network and the available resources for the one or more components of the distributed antenna system by: instantiating one or more network functions for the private network at the master unit and/or at the one or more intermediary combining nodes; selecting physical hardware to instantiate the one or more network functions for the private network; and/or determining dimensioning of a transport network of the distributed antenna system to support the requirements for the private network.

Example 17 includes the system of any of Examples 15-16, wherein the at least one controller is configured to dedicate resources of the distributed antenna system to the private network based on requirements of the private network and the available resources for the one or more components of the distributed antenna system by: dedicating processing resources, memory, storage, and/or network resources of the master unit, the one or more intermediary combining nodes, and the plurality of radio units to the private network; and dedicating network resources of the one or more switches to the private network.

Example 18 includes the system of any of Examples 10-17, wherein the at least one controller is configured to dedicate resources of the distributed antenna system to the private network based on requirements of the private network and the available resources for the one or more components of the distributed antenna system by associating a Public Land Mobile Network (PLMN) identifier of the private network with the resources of the distributed antenna system dedicated to the private network; wherein the system is configured to utilize the resources of the distributed antenna system dedicated to the private network for traffic having an identifier corresponding to the private network by routing traffic that includes the identifier corresponding to the PLMN identifier for the private network to the resources of the distributed antenna system dedicated to the private network.

Example 19 includes the system of any of Examples 10-18, wherein the master unit is communicatively coupled to one or more base station entities of a second network different from the private network; wherein the plurality of radio units includes a first set of radio units and a second set of radio units, the first set of radio units being dedicated to the private network; wherein the master unit is configured to monitor signals from the one or more base station entities of the private network and signals from the one or more base station entities of the second network for the identifier corresponding to the private network; wherein the master unit is configured to route the signals from the one or more base station entities of the private network having the identifier corresponding to the private network to the first set of radio units; wherein the master unit is configured to route the signals having the identifier corresponding to the private network to the first set of radio units; and wherein the master unit is configured to route the signals not having the identifier corresponding to the private network to the second set of radio units.

Example 20 includes the system of any of Examples 10-19, wherein one or more components of the system are further configured to: determine whether a first network slice is activated and connected to the distributed antenna system; determine one or more paths of the distributed antenna system impacted by the first network slice; dedicate resources of the distributed antenna system to the first network slice based on requirements of the first network slice and the available resources for the one or more components of the distributed antenna system; and utilize the resources of the distributed antenna system dedicated to the first network slice for traffic corresponding to the first network slice.

Example 21 includes a method for supporting network slices in a distributed antenna system, the method comprising: determining whether a first network slice is activated and connected to the distributed antenna system; determining one or more paths of the distributed antenna system impacted by the first network slice; receiving an indication of available resources for one or more components in the distributed antenna system; dedicating resources of the distributed antenna system to the first network slice based on requirements of the first network slice and the available resources for the one or more components of the distributed antenna system; and utilizing the resources of the distributed antenna system dedicated to the first network slice for traffic corresponding to the first network slice.

Example 22 includes the method of Example 21, wherein determining whether the first network slice is activated and connected to the distributed antenna system includes monitoring control messages for an identifier of the first network slice.

Example 23 includes the method of any of Examples 21-22, wherein determining whether the first network slice is activated and connected to the distributed antenna system includes obtaining an indication that the first network slice is activated from an external system, wherein the external system is separate from the distributed antenna system.

Example 24 includes the method of any of Examples 21-23, wherein determining one or more paths of the distributed antenna system impacted by the first network slice includes using topology information for the distributed antenna system, location information for nodes of the distributed antenna system, and characteristics of one or more flows supported by the distributed antenna system.

Example 25 includes the method of any of Examples 21-24, wherein the distributed antenna system includes a master unit communicatively coupled to and located remotely from a plurality of radio units, wherein the master unit is communicatively coupled to the plurality of radio units via one or more switches and one or more intermediary combining nodes.

Example 26 includes the method of Example 25, wherein dedicating resources of the distributed antenna system to the first network slice based on requirements of the first network slice and the available resources for the one or more components of the distributed antenna system includes: instantiating one or more network functions for the first network slice at the master unit and/or at the one or more intermediary combining nodes; selecting physical hardware to instantiate the one or more network functions for the first network slice;

and/or determining dimensioning of a transport network of the distributed antenna system to support the requirements for the first network slice.

Example 27 includes the method of any of Examples 25-26, wherein dedicating resources of the distributed antenna system to the first network slice based on requirements of the first network slice and the available resources for the one or more components of the distributed antenna system includes: dedicating processing resources, memory, storage, and/or network resources of the master unit, the one or more intermediary combining nodes, and the plurality of radio units to the first network slice; and dedicating network resources of the one or more switches to the first network slice.

Example 28 includes the method of any of Examples 21-27, wherein dedicating resources of the distributed antenna system to the first network slice based on requirements of the first network slice and the available resources for the one or more components of the distributed antenna system includes associating an identifier of the first network slice with the resources of the distributed antenna system dedicated to the first network slice; wherein utilizing the resources of the distributed antenna system dedicated to the first network slice for traffic corresponding to the first network slice includes routing traffic that includes the identifier for the first network slice to the resources of the distributed antenna system dedicated to the first network slice.

Example 29 includes the method of any of Examples 21-28, further comprising: determining whether a second network slice is activated and connected to the distributed antenna system; determining one or more paths of the distributed antenna system impacted by the second network slice; dedicating resources of the distributed antenna system to the second network slice based on requirements of the second network slice and the available resources for the one or more components of the distributed antenna system; and utilizing the resources of the distributed antenna system dedicated to the second network slice for traffic corresponding to the second network slice.

Example 30 includes a system, comprising: a master unit of a distributed antenna system, wherein the master unit is configured to be coupled to one or more base station entities; a plurality of radio units of the distributed antenna system communicatively coupled to the master unit, wherein the plurality of radio units is located remotely from the master unit; and at least one controller communicatively coupled to the master unit and the plurality of radio units; wherein one or more components of the system are configured to: determine whether a first network slice is activated and connected to the distributed antenna system;

determine one or more paths of the distributed antenna system impacted by the first network slice; receive an indication of available resources for one or more components in the distributed antenna system; dedicate resources of the distributed antenna system to the first network slice based on requirements of the first network slice and the available resources for the one or more components of the distributed antenna system; and utilize the resources of the distributed antenna system dedicated to the first network slice for traffic corresponding to the first network slice.

Example 31 includes the system of Example 30, wherein the at least one controller and/or the master unit is configured to determine whether a first network slice is activated and connected to the distributed antenna system.

Example 32 includes the system of any of Examples 30-31, wherein the master unit is configured to determine whether a first network slice is activated and connected to the distributed antenna system by monitoring control messages for an identifier of the first network slice.

Example 33 includes the system of any of Examples 30-32, wherein the at least one controller and/or the master unit is configured to determine whether the first network slice is activated and connected to the distributed antenna system based on an indication that the first network slice is activated from an external system, wherein the external system is separate from the distributed antenna system.

Example 34 includes the system of any of Examples 30-33, wherein the at least one controller and/or the master unit is configured to determine the one or more paths of the distributed antenna system impacted by the first network slice includes using topology information for the distributed antenna system, location information for nodes of the distributed antenna system, and characteristics of one or more flows supported by the distributed antenna system.

Example 35 includes the system of any of Examples 30-34, wherein the master unit is communicatively coupled to the plurality of radio units via one or more switches and one or more intermediary combining nodes.

Example 36 includes the system of Example 35, wherein the at least one controller is configured to dedicate resources of the distributed antenna system to the first network slice based on requirements of the first network slice and the available resources for the one or more components of the distributed antenna system by: instantiating one or more network functions for the first network slice at the master unit and/or at the one or more intermediary combining nodes; selecting physical hardware to instantiate the one or more network functions for the first network slice; and/or determining dimensioning of a transport network of the distributed antenna system to support the requirements for the first network slice.

Example 37 includes the system of any of Examples 35-36, wherein the at least one controller is configured to dedicate resources of the distributed antenna system to the first network slice based on requirements of the first network slice and the available resources for the one or more components of the distributed antenna system by: dedicating processing resources, memory, storage, and/or network resources of the master unit, the one or more intermediary combining nodes, and the plurality of radio units to the first network slice; and dedicating network resources of the one or more switches to the first network slice.

Example 38 includes the system of any of Examples 30-37, wherein the at least one controller is configured to dedicate resources of the distributed antenna system to the first network slice based on requirements of the first network slice and the available resources for the one or more components of the distributed antenna system by associating an identifier of the first network slice with the resources of the distributed antenna system dedicated to the first network slice; wherein the one or more components of the system are configured to utilize the resources of the distributed antenna system dedicated to the first network slice for traffic corresponding to the first network slice includes routing traffic that includes the identifier for the first network slice to the resources of the distributed antenna system dedicated to the first network slice.

Example 39 includes the system of any of Examples 30-38, wherein the one or more components of the system are further configured to: determine whether a second network slice is activated and connected to the distributed antenna system; determine one or more paths of the distributed antenna system impacted by the second network slice; dedicate resources of the distributed antenna system to the second network slice based on requirements of the second network slice and the available resources for the one or more components of the distributed antenna system; and utilize the resources of the distributed antenna system dedicated to the second network slice for traffic corresponding to the second network slice.

Example 40 includes the system of Example 39, wherein the master unit is further configured to: route the traffic corresponding to the first network slice to first components of the distributed antenna system in response to the traffic including a first identifier associated with the first network slice; and route the traffic corresponding to the second network slice to second components of the distributed antenna system different than the first components of the distributed antenna system in response to the traffic including a second identifier associated with the second network slice.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A method for supporting a private network with a distributed antenna system, the method comprising:
determining whether a private network is activated and connected to the distributed antenna system;
determining one or more paths of the distributed antenna system impacted by the private network;
receiving an indication of available resources and capability information for one or more components in the distributed antenna system;
dedicating resources of the distributed antenna system to the private network based on requirements of the private network and the available resources for the one or more components of the distributed antenna system; and
utilizing the resources of the distributed antenna system dedicated to the private network for traffic having an identifier corresponding to the private network.

2. The method of claim 1, wherein determining one or more paths of the distributed antenna system impacted by the private network is based on Public Land Mobile Network (PLMN) information for the private network, topology information for the distributed antenna system, location information for nodes of the distributed antenna system, and/or characteristics of one or more flows supported by the distributed antenna system.

3. The method of claim 1, further comprising determining a location for one or more core network entities and one or more base station entities for the private network that will reduce latency for user-plane data for the private network.

4. The method of claim 3, wherein determining the location for one or more core network entities and the one or more base station entities for the private network includes:
determining a location for one or more user plane functions (UPFs) for the private network;
determining a location for one or more central units (CUs) for the private network; and/or
determining a location for one or more distributed units (DUs) for the private network.

5. The method of claim 1, further comprising determining one or more split options to enable for the private network based on the requirements of the private network, the indication of available resources for the one or more components of the distributed antenna system, and the capability information for the one or more components of the distributed antenna system.

6. The method of claim 1, wherein the distributed antenna system includes a master unit communicatively coupled to and located remotely from a plurality of radio units, wherein the master unit is communicatively coupled to the plurality of radio units via one or more switches and one or more intermediary combining nodes.

7. The method of claim 6, wherein dedicating resources of the distributed antenna system to the private network based on the requirements of the private network and the available resources for the one or more components of the distributed antenna system includes:
instantiating one or more network functions for the private network at the master unit and/or at the one or more intermediary combining nodes;
selecting physical hardware to instantiate the one or more network functions for the private network; and/or
determining dimensioning of a transport network of the distributed antenna system for the one or more switches to support the requirements for the private network.

8. The method of claim 6, wherein dedicating resources of the distributed antenna system to the private network based on requirements of the private network and the available resources for the one or more components of the distributed antenna system includes:
dedicating processing resources, memory, storage, and/or network resources of the master unit, the one or more intermediary combining nodes, and the plurality of radio units to the private network; and
dedicating network resources of the one or more switches to the private network.

9. The method of claim 1, wherein dedicating resources of the distributed antenna system to the private network based on the requirements of the private network and the available resources for the one or more components of the distributed antenna system includes associating a Public Land Mobile Network (PLMN) identifier of the private network with the resources of the distributed antenna system dedicated to the private network;
wherein utilizing the resources of the distributed antenna system dedicated to the private network for traffic having an identifier corresponding to the private network includes routing traffic that includes an identifier corresponding to the PLMN identifier of the private network to the resources of the distributed antenna system dedicated to the private network.

10. A system, comprising:
a master unit of a distributed antenna system, wherein the master unit is configured to be coupled to one or more base station entities of a private network;
a plurality of radio units of the distributed antenna system communicatively coupled to the master unit, wherein the plurality of radio units is located remotely from the master unit; and
at least one controller communicatively coupled to the master unit, wherein the at least one controller is configured to:
determine whether the private network is activated and connected to the distributed antenna system;
determine one or more paths of the distributed antenna system impacted by the private network;
receive an indication of available resources and capability information for one or more components in the distributed antenna system; and
dedicate resources of the distributed antenna system to the private network based on requirements of the private network and the available resources for the one or more components of the distributed antenna system;
wherein the system is configured to utilize the resources of the distributed antenna system dedicated to the private network for traffic having an identifier corresponding to the private network.

11. The system of claim 10, wherein the at least one controller is further configured to determine a location for one or more core network entities and the one or more base station entities for the private network that will reduce latency for user-plane data for the private network.

12. The system of claim 11, wherein the at least one controller is configured to:
determine a location for one or more user plane functions (UPFs) for the private network;
determine a location for one or more central units (CUs) for the private network; and/or
determine a location for one or more distributed units (DUs) for the private network.

13. The system of claim 10, wherein the at least one controller is further configured to determine one or more split options to enable for the private network based on the requirements of the private network, the indication of available resources for the one or more components of the distributed antenna system, and the capability information for the one or more components of the distributed antenna system.

14. The system of claim 10, wherein the at least one controller is configured to determine the one or more paths of the distributed antenna system impacted by the private network includes using topology information for the distributed antenna system, location information for nodes of the distributed antenna system, and characteristics of one or more flows supported by the distributed antenna system.

15. The system of claim 10, wherein the master unit is communicatively coupled to the plurality of radio units via one or more switches and one or more intermediary combining nodes.

16. The system of claim 15, wherein the at least one controller is configured to dedicate resources of the distributed antenna system to the private network based on requirements of the private network and the available resources for the one or more components of the distributed antenna system by:
instantiating one or more network functions for the private network at the master unit and/or at the one or more intermediary combining nodes;
selecting physical hardware to instantiate the one or more network functions for the private network; and/or
determining dimensioning of a transport network of the distributed antenna system to support the requirements for the private network.

17. The system of claim 15, wherein the at least one controller is configured to dedicate resources of the distributed antenna system to the private network based on requirements of the private network and the available resources for the one or more components of the distributed antenna system by:
dedicating processing resources, memory, storage, and/or network resources of the master unit, the one or more intermediary combining nodes, and the plurality of radio units to the private network; and
dedicating network resources of the one or more switches to the private network.

18. The system of claim 10, wherein the at least one controller is configured to dedicate resources of the distributed antenna system to the private network based on requirements of the private network and the available resources for the one or more components of the distributed antenna system by associating a Public Land Mobile Network (PLMN) identifier of the private network with the resources of the distributed antenna system dedicated to the private network;
wherein the system is configured to utilize the resources of the distributed antenna system dedicated to the private network for traffic having an identifier corresponding to the private network by routing traffic that includes the identifier corresponding to the PLMN identifier for the private network to the resources of the distributed antenna system dedicated to the private network.

19. The system of claim 10, wherein the master unit is communicatively coupled to one or more base station entities of a second network different from the private network;
wherein the plurality of radio units includes a first set of radio units and a second set of radio units, the first set of radio units being dedicated to the private network;
wherein the master unit is configured to monitor signals from the one or more base station entities of the private network and signals from the one or more base station entities of the second network for the identifier corresponding to the private network;
wherein the master unit is configured to route the signals from the one or more base station entities of the private network having the identifier corresponding to the private network to the first set of radio units;
wherein the master unit is configured to route the signals having the identifier corresponding to the private network to the first set of radio units; and
wherein the master unit is configured to route the signals not having the identifier corresponding to the private network to the second set of radio units.

20. The system of claim 10, wherein one or more components of the system are further configured to:
determine whether a first network slice is activated and connected to the distributed antenna system;
determine one or more paths of the distributed antenna system impacted by the first network slice;
dedicate resources of the distributed antenna system to the first network slice based on requirements of the first network slice and the available resources for the one or more components of the distributed antenna system; and
utilize the resources of the distributed antenna system dedicated to the first network slice for traffic corresponding to the first network slice.
